(19) United States
(12) Patent Application Publication
(10) Pub. No.: US 2026/0226708 A1
(43) Pub. Date: Aug. 6, 2026

(54) Switching Between Local And Remote Control Of Autonomous Powered Earth-Moving Construction Or Mining Vehicles

(71) Applicant: AIM Intelligent Machines, Inc., Redmond, WA (US)

(72) Inventors: Adam Sadilek, Monroe, WA (US); Robert Kotlaba, Most (CZ)

(21) Appl. No.: 19/530,029

(22) Filed: Feb. 4, 2026

Related U.S. Application Data
(60) Provisional application No. 63/754,352, filed on Feb. 5, 2025.

(51) Int. Cl. E02F 9/20; G05D 1/223; G05D 1/226; G05D 1/227; G05D 1/242; G05D 1/248; G05D 105/05

(52) U.S. Cl. CPC E02F 9/205; E02F 9/2054; G05D 1/223; G05D 1/226; G05D 1/227; G05D 1/242; G05D 1/248; G05D 2105/05

(57) ABSTRACT

Systems and techniques are described for implementing autonomous control of powered earth-moving vehicles, including remote control switching, from manual control of a first earth-moving vehicle by a human operator user on the first vehicle using physical control components of the first vehicle, to virtual control of a remote second earth-moving vehicle using the physical control components of the first vehicle. For example, remote control switching may include switching from manual control of a first earth-moving mining and/or construction vehicle to virtual control of a second separate earth-moving mining and/or construction vehicle of a same type where control signals generated from manipulation of physical control components on the first vehicle by the human operator are transmitted to a control unit on the second vehicle, to enable the human operator to virtually operate the second earth-moving mining and/or construction vehicle from the first vehicle.

### CROSS REFERENCE TO RELATED APPLICATIONS

This application claims the benefit of U.S. Provisional Patent Application No. 63/754,352, filed Feb. 5, 2025 and entitled “Remote Control Switching Of Separate Autonomous Powered Earth-Moving Construction Or Mining Vehicles”, which is hereby incorporated by reference in its entirety.

### TECHNICAL FIELD

The following disclosure relates generally to systems and techniques for autonomous control of powered earth-moving construction and/or mining vehicles, such as to determine and implement autonomous operations of one or more powered earth-moving vehicles on a site that include switching from local manual control of a first earth-moving vehicle by a human operator user on the first vehicle to remote control of a second earth-moving vehicle using the controls of the first vehicle to remotely operate the second vehicle.

### BACKGROUND

Earth-moving construction vehicles (e.g., loaders, excavators, bulldozers, deep sea machinery, extra-terrestrial machinery, etc.) may be used on a job site to move soil and other materials (e.g., gravel, rocks, asphalt, etc.) and to perform other operations, and are each typically operated by a human operator (e.g., a human user present inside a cabin of the construction vehicle, a human user at a location separate from the construction vehicle but performing interactive remote control of the construction vehicle, etc.). Similarly, earth-moving mining vehicles may be used to extract or otherwise move soil and other materials (e.g., gravel, rocks, asphalt, etc.) and to perform other operations, and are each typically operated by a human operator (e.g., a human user present inside a cabin of the mining vehicle, a human user at a location separate from the mining vehicle but performing interactive remote control of the mining vehicle, etc.).

Limited fully autonomous operations (e.g., performed under automated programmatic control without human user interaction or intervention) of some construction and mining vehicles have occasionally been used, but existing techniques suffer from a number of problems, including the use of limited types of sensed data, an inability to perform fully autonomous operations when faced with on-site obstacles, an inability to coordinate autonomous operations between multiple on-site construction and/or mining vehicles, requirements for bulky and expensive hardware systems to support the limited autonomous operations, etc.

### BRIEF DESCRIPTION OF THE DRAWINGS

FIG. 1A is a network diagram illustrating an example embodiment of using described systems and techniques to determine and implement autonomous operations of one or more powered earth-moving vehicles on a site, including to perform remote control switching from local manual control of a first powered earth-moving vehicle to remote control of a second powered earth-moving vehicle using the physical controls of the first powered earth-moving vehicle.

FIG. 1B is a diagram illustrating example components and interactions used to implement autonomous operations of one or more powered earth-moving vehicles on a site.

FIG. 1C illustrates an example worksite for remote control switching from local manual control of a first powered earth-moving vehicle to remote control of a second powered earth-moving vehicle using the physical controls of the first powered earth-moving vehicle.

FIGS. 2A-2I illustrate examples of powered earth-moving vehicles having an on-vehicle autonomous operations control system and multiple types of on-vehicle data sensors positioned to support autonomous operations on a site.

FIGS. 3A-3B are example flow diagrams of an illustrated embodiment of performing remote control of a second earth-moving vehicle using physical controls of a separate first earth-moving vehicle, such as by switching from local manual control of the first earth-moving vehicle using local manual manipulations of physical controls of the first earth-moving vehicle to remote control of the second earth-moving vehicle from the first earth-moving vehicle using further manual manipulations of the physical controls of the first earth-moving vehicle.

### DETAILED DESCRIPTION

Systems and techniques are described for implementing autonomous control of operations of powered earth-moving vehicles (e.g., construction and/or mining vehicles) on a site, including to automatically control movement of hydraulic arm(s) and/or of tool attachment(s) and/or of other vehicle component parts (e.g., wheels or tracks, a rotatable body, etc.) of one or more powered earth-moving vehicles on a job site. In at least some embodiments, the described techniques include using remote control switching, from manual local control of a first powered earth-moving vehicle using manual manipulations of first physical controls of the first vehicle by a human operator on the first powered earth-moving vehicle (e.g., in a cabin of the vehicle body), to remote control of a second earth-moving vehicle using further manual manipulations of the first physical controls of the first powered earth-moving vehicle. In addition, in at least some embodiments, the first and second powered earth-moving vehicles are of equivalent types for which the first physical controls (e.g., joysticks, pedals, buttons, etc.) of the first powered earth-moving vehicle may substitute for other second physical controls of the second powered earth-moving vehicle, such as by being the same type of vehicle and/or having the same or overlapping types of physical controls and/or having the same or overlapping configuration of movable components.

In some embodiments and situations, the autonomous control of operations of a powered earth-moving vehicle is performed as part of fully autonomous operations of the powered earth-moving vehicle without any human input during those fully autonomous operations (e.g., to receive human input only to provide information about task goals and/or other configuration settings before the fully autonomous operations commence), including planning motion of the powered earth-moving vehicle between on-site locations and/or movement of component parts of the vehicle (e.g., hydraulic arms, tool attachments, a rotatable body atop an underlying chassis with undercarriage, etc.). In some embodiments and situations, the autonomous control of the operations of a powered earth-moving vehicle is performed as part of semi-autonomous operations of the powered earth-moving vehicle, including monitoring manipulation of some or all physical controls of the vehicle by one or more human operators (whether located in or on the vehicle, or instead remote from the vehicle) during the vehicle operations. Controlled operations of the powered earth-moving vehicle may in some embodiments and situations be performed while the vehicle remains at a fixed location (e.g., for a tracked excavator vehicle, to include movements such as body rotation and/or hydraulic arm movements and/or tool attachment movements, but not to include movement of the tracks), and may in some embodiments and situations be performed as the vehicle is in motion from an initial location to a destination location. Additional details related to implementing autonomous control of powered earth-moving vehicles in particular manners are described below, and some or all of the described techniques are performed in at least some embodiments by automated operations of an Earth-Moving Vehicle Autonomous Operations Control (“EMVAOC”) system to control one or more powered earth-moving vehicles (e.g., an EMVAOC system operating on at least one powered earth-moving vehicle being controlled).

In some implementations, during autonomous control, the EMVAOC system may obtain and integrate data from sensors of multiple types positioned on a powered earth-moving vehicle at a site, and use the data to determine and control motion of the powered earth-moving vehicle on the site, such as by determining current location and positioning of the powered earth-moving vehicle and its movable component parts on the site, determining a target destination location and/or route (or ‘path’) of the powered earth-moving vehicle on the site, identifying and classifying objects and other obstacles (e.g., man-made structures, rocks and other naturally occurring impediments, other equipment, people or animals, non-level terrain, etc.) along one or more possible paths (e.g., multiple alternative paths between current and destination locations), implementing actions to address any such obstacles (e.g., move, avoid, pass over, etc.), and performing balancing-related and slippage-related operations as needed during vehicle motion on non-level surfaces. In addition, in at least some embodiments, the described systems and techniques are further used to implement coordinated actions of multiple powered earth-moving vehicles of one or more types (e.g., one or more excavator vehicles, bulldozer vehicles, front loader vehicles, grader vehicles, loader vehicles, crane vehicles, backhoe vehicles, compactor vehicles, conveyor vehicles, dump trucks or other truck vehicles, etc.).

A powered earth-moving vehicle may further use additional sensors on some or all movable component parts of the vehicle to determine positions of those component parts, including relative to other parts of the vehicle. As one non-exclusive example, a first hydraulic arm attached to a body of the vehicle (e.g., a hydraulic ‘boom’ arm of an excavator vehicle) may include at least one inclinometer sensor that measures an angle of that first hydraulic arm relative to the body, a second hydraulic arm (if any) attached to the first hydraulic arm (e.g., a hydraulic ‘stick’ arm of an excavator vehicle attached to a hydraulic boom arm) may include at least one additional inclinometer sensor that measures an angle of that second hydraulic arm relative to the first hydraulic arm, a tool attachment connected to one of the hydraulic arms (e.g., a bucket tool of an excavator vehicle connected to the hydraulic stick arm) may include at least one additional inclinometer sensor that measures an angle of that tool attachment relative to that hydraulic arm to which it is connected, etc.—a combination of the angles for such hydraulic arm(s) and tool attachment may then be used to determine positions in three-dimensional (3D) space of those component parts relative to a connection point to the vehicle body. In addition, a cabin or other portion of the body may include one or more sensors to provide relative or absolute location and/or orientation/direction information (e.g., one or more GPS receivers, such as multiple GPS receivers at known locations on the body to in combination provide directional information for the body; one or more INS-DU, or inertial navigation system—dual antenna, sensors that combine GPS data with compass data and other IMU, data such as acceleration and angular velocity; etc.), and tracks or wheels of the vehicle may include one or more directional sensors to determine a direction of the tracks/wheels and the undercarriage portion of the chassis to which they connect (whether an absolute direction and/or a direction relative to the body if the body is rotatable), with the relative directions of the tracks/wheels able to be used to determine positions in 3D space of those component parts relative to the vehicle body—if the sensors on the vehicle are able to determine an absolute position of the vehicle body, the positions of the vehicle component parts may further be determined in absolute coordinates, such as by using GPS coordinates from one or more GPS antennas mounted on the body, optionally after being corrected using real-time kinematic (RTK)-based GPS correction data transmitted via signals from a base station (e.g., at a location remote from the site at which the vehicle is located), and/or by using LiDAR and/or visual data to determine a position of the vehicle within a job site with known locations. The positions of the vehicle component parts may be represented in various manners in various embodiments (e.g., in XYZ coordinates, whether absolute or relative to one or more positions on the vehicle body; in angle-based coordinates, such as to represent the position of an excavator vehicle's tool attachment using the first angle for the hydraulic boom arm and the second angle for the hydraulic stick arm and the third angle for the tool attachment; etc.)—the positions of the obstacles around the vehicle may similarly be represented in the same format as used for the vehicle component parts (e.g., in angle-based coordinates relative to the same point on the vehicle's body as for movable component parts of the vehicle whose positions use such angle-based coordinates), or instead different position formats may be used for vehicle component parts, with a conversion determined between formats during use of the vehicle component part position information and the information about the obstacle locations.

As noted above, the automated operations of the EMVAOC system may include automatically planning powered earth-moving vehicle motion between two or more locations (e.g., between starting and ending locations on a site) and/or vehicle attachment movements while the vehicle is stationary and/or in motion. In some embodiments, the EMVAOC system may include one or more planner modules, and at least one such planner module may perform such planning operations for one or more vehicle component parts, such as to determine a 3D movement/motion plan that includes a sequence of 3D positions for a vehicle's tool attachment to perform one or more tasks, optionally while the vehicle moves on a path between multiple locations (e.g., in accordance with other goals or planning operations being performed by the EMVAOC system, such as based on an overall analysis of a site and/or as part of accomplishing a group of multiple activities at the site). These techniques may be further extended for motion of the vehicle between different locations on a job site, such as when moving to a destination location at which one or more tasks will be performed, while moving between locations as part of implementing one or more tasks (e.g., carrying or otherwise moving material between two locations), etc.

For illustrative purposes, some embodiments are described below in which specific types of data are acquired and used for specific types of automated operations performed for specific types of powered earth-moving vehicles, and in which specific types of autonomous operation activities are performed in particular manners. However, it will be understood that such described systems and techniques may be used with other types of data and powered earth-moving vehicles and associated autonomous operation activities in other manners in other embodiments, and that the invention is thus not limited to the exemplary details provided. In addition, the terms “acquire” or “capture” or “record” as used herein with reference to sensor data may refer to any recording, storage, or logging of media, sensor data, and/or other information related to a powered earth-moving vehicle or job site or other location or subsets thereof (unless context clearly indicates otherwise), such as by a recording device or by another device that receives information from the recording device. In addition, various details are provided in the drawings and text for exemplary purposes, but are not intended to limit the scope of the invention. For example, sizes and relative positions of elements in the drawings are not necessarily drawn to scale, with some details omitted and/or provided with greater prominence (e.g., via size and positioning) to enhance legibility and/or clarity. Furthermore, identical reference numbers may be used in the drawings to identify similar elements or acts.

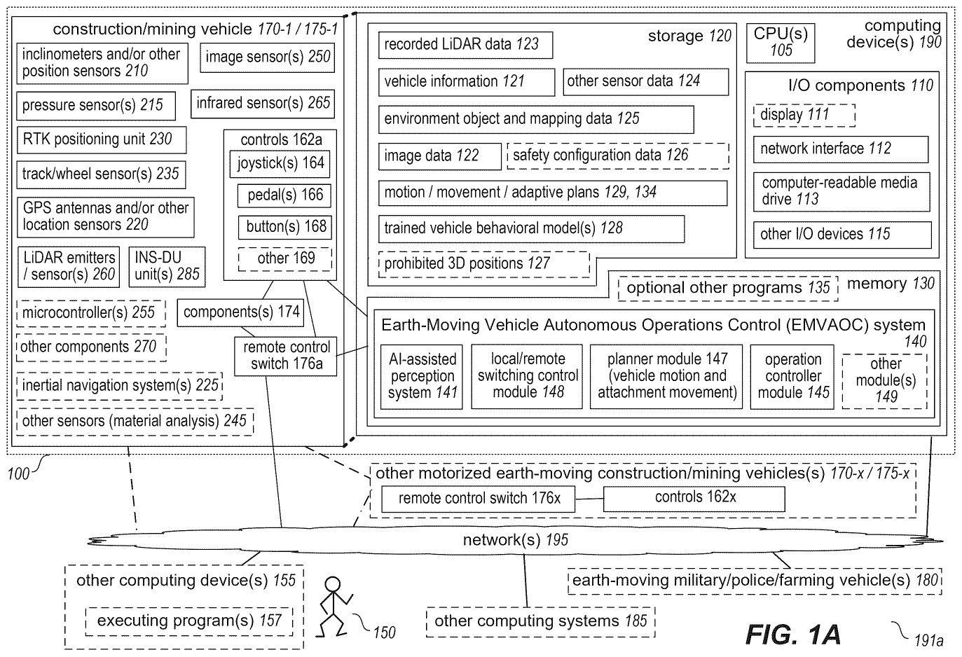

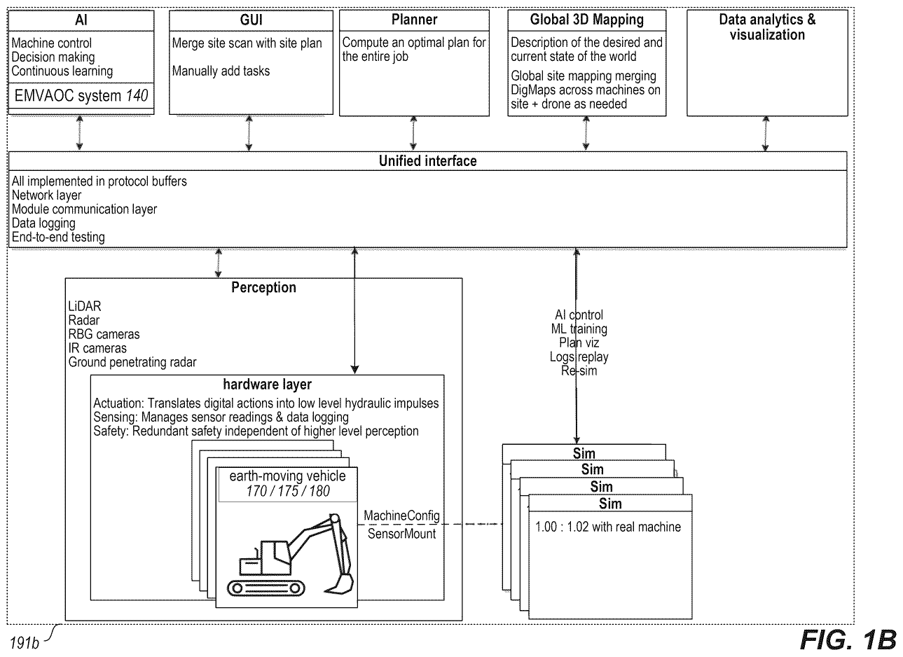

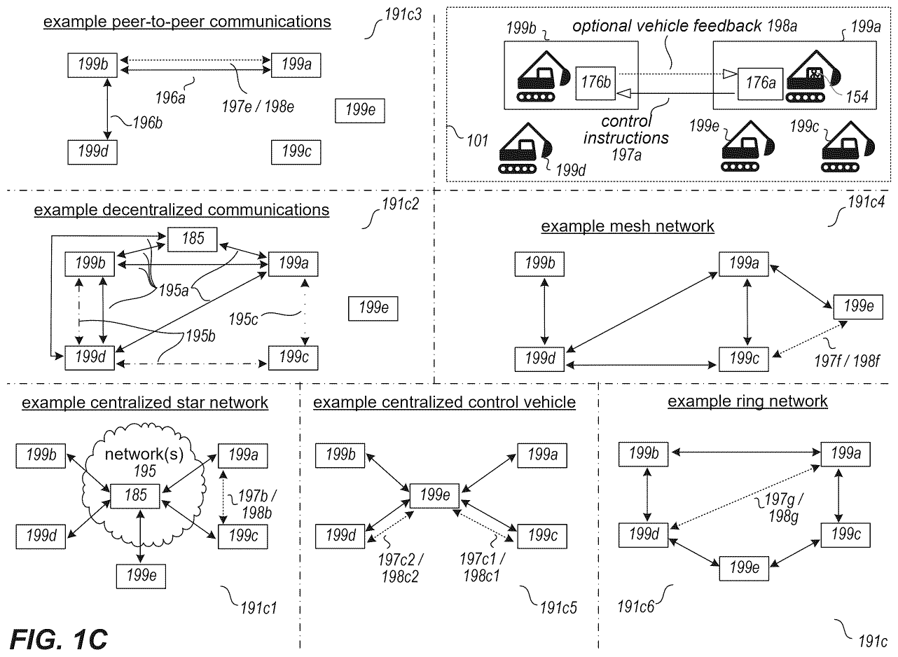

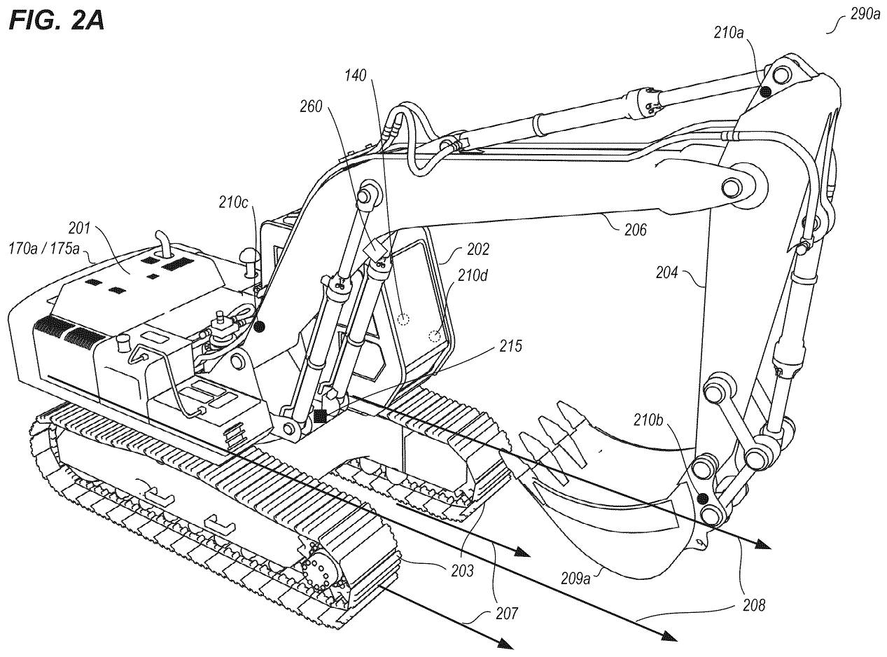

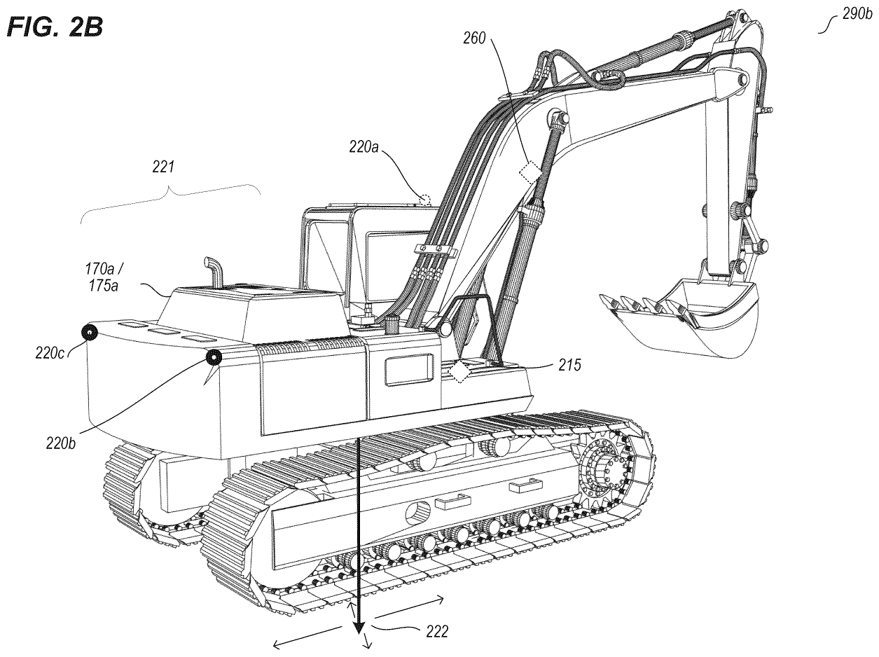

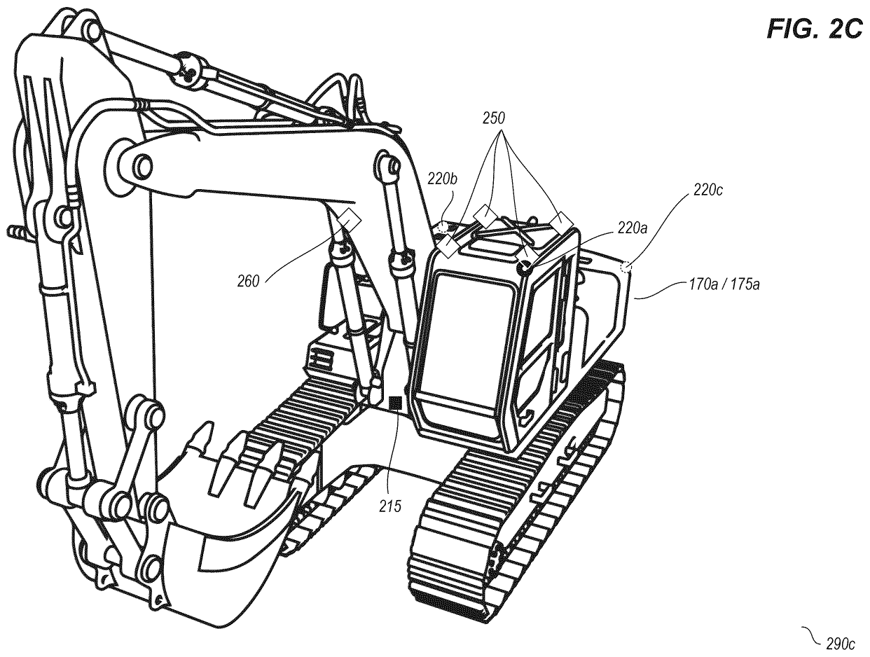

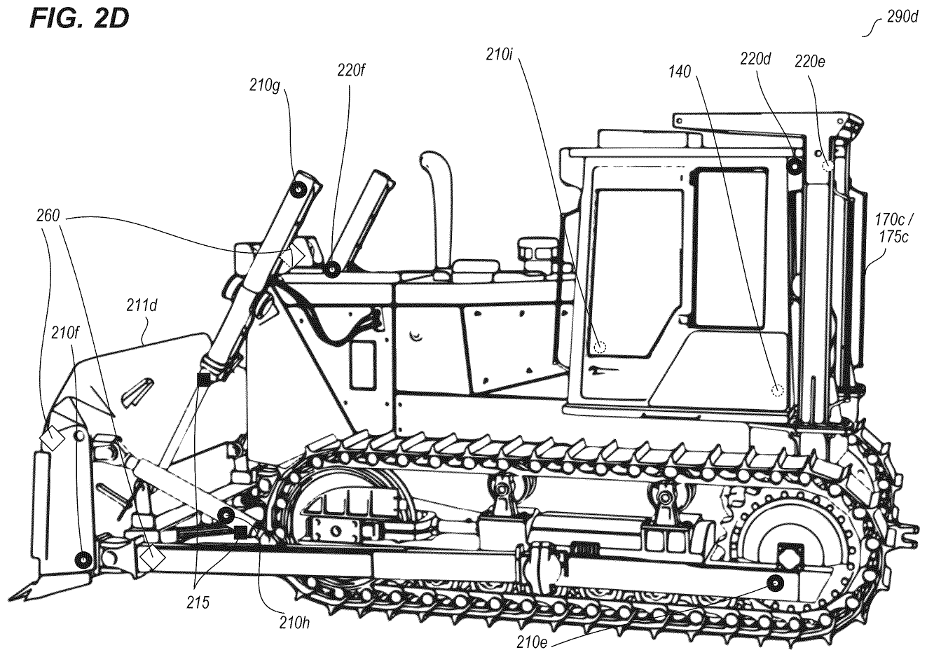

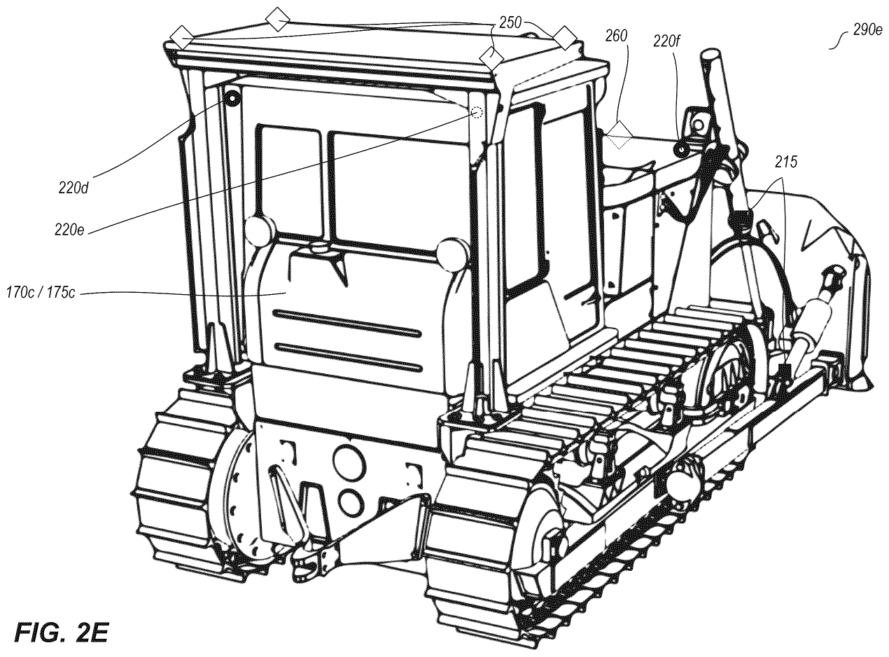

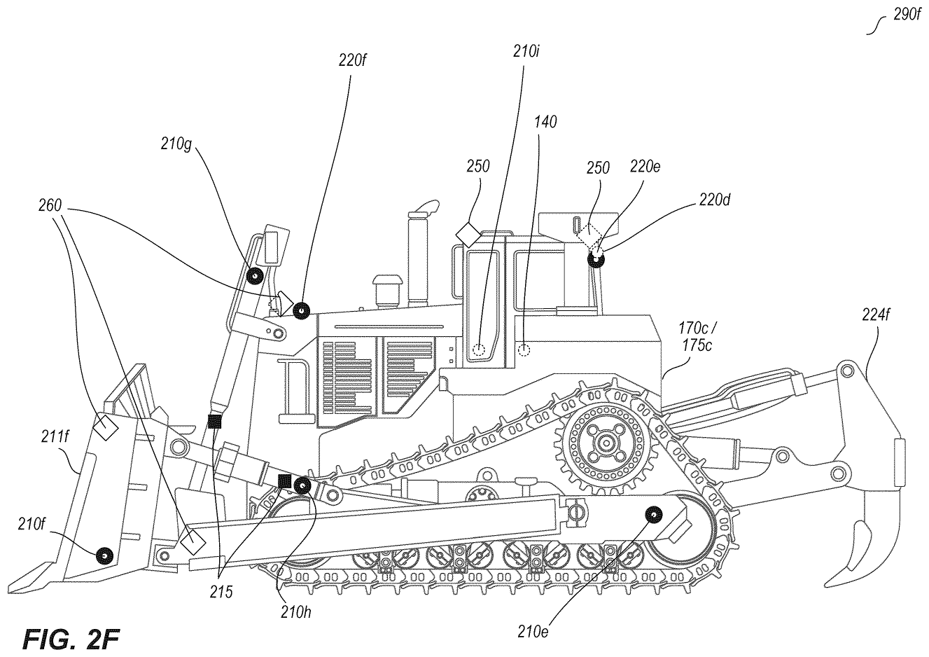

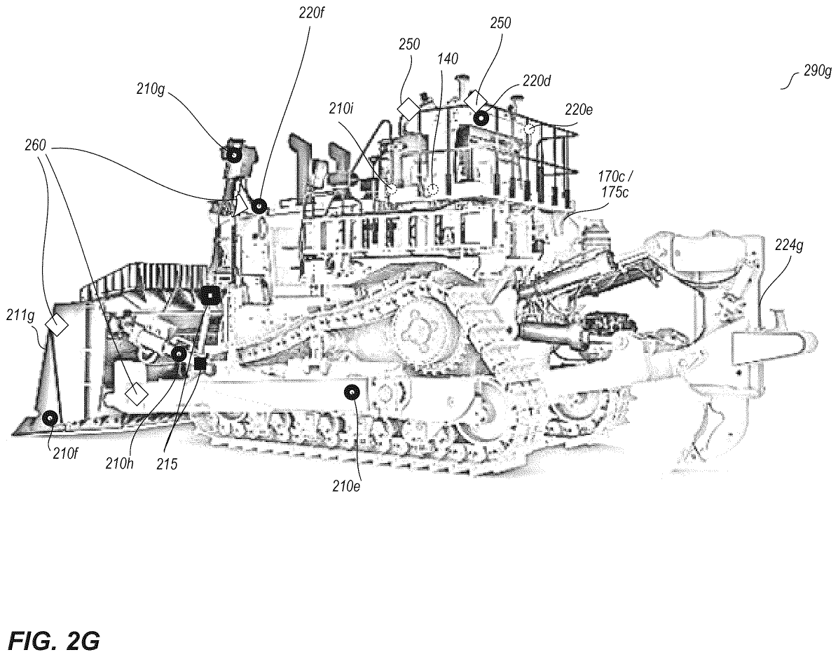

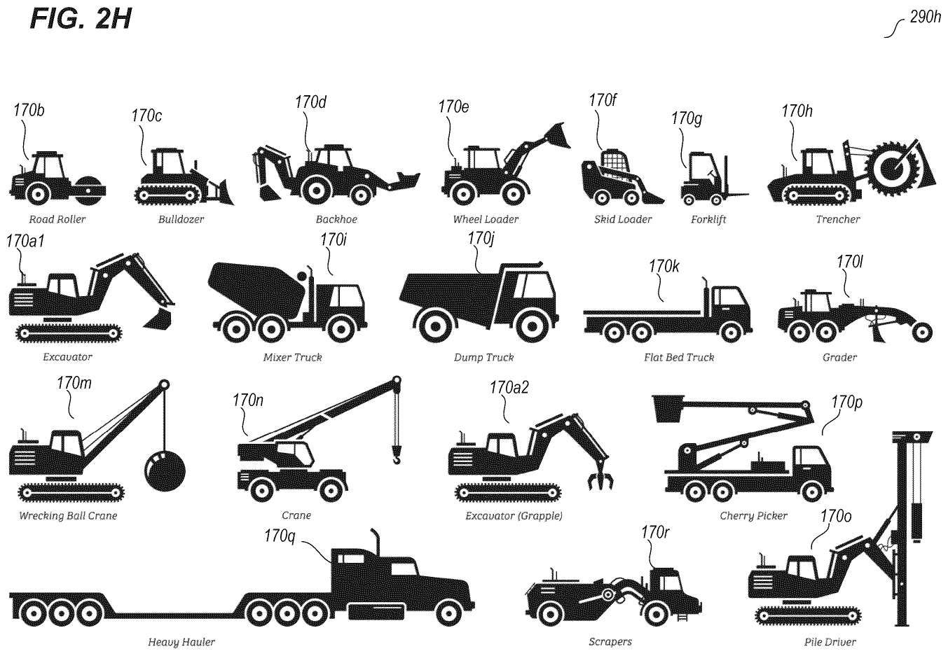

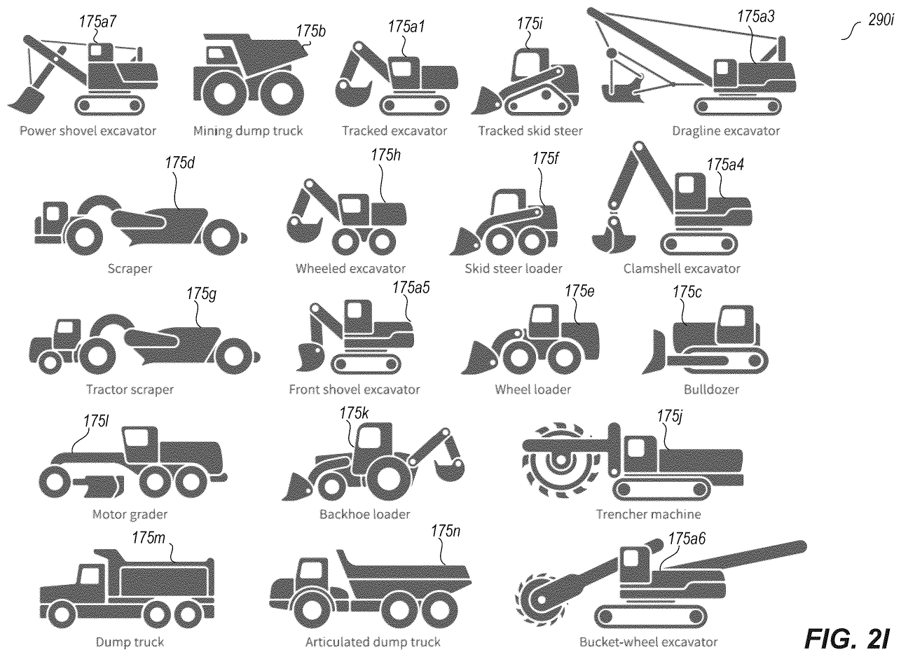

FIG. 1A is a diagram illustrating information 191a including an example embodiment of an EMVAOC (“Earth-Moving Vehicle Autonomous Operations Control”) system 140 that may be used to implement at least some of the described systems and techniques for implementing autonomous control of powered earth-moving vehicles and remote control switching from manual control of a first earth-moving vehicle to remote control of a second earth-moving vehicle. The EMVAOC system 140 may be implemented using one or more hardware processors 105, such as part of one or more network-accessible configured computing devices 190—such a computing device may in some embodiments and situations be part of a self-contained control unit located on a powered earth-moving vehicle (e.g., without a separate cooling unit, and operable without receiving external instructions), such as when the EMVAOC system 140 is part of otherwise integrated 100 with a particular powered earth-moving construction vehicle 170-1 and/or powered earth-moving mining vehicle 175-1 (e.g., located on that powered earth-moving vehicle) and/or other powered earth-moving vehicle(s) 180 (e.g., located on that powered earth-moving vehicle), such as one or more military vehicles and/or police vehicles and/or farming vehicles. In other embodiments and situations, the EMVAOC system 140 may support multiple powered earth-moving vehicles 170 and/or 175 and/or 180 (e.g., operating in a distributed manner on the multiple vehicles, such as one computing device 190 on each of the multiple vehicles that are interacting in a peer-to-peer manner), or instead operate remotely from one or more such powered earth-moving vehicles 170 and/or 175 and/or 180 (e.g., at a location on site and in communication with one or more such powered earth-moving vehicles over one or more networks 195, including via use of local/remote switching control module 148). In some embodiments, one or more other computing devices or systems may further interact with the EMVAOC system 140 (e.g., to obtain and/or provide information), such as one or more other computing devices 155 each having one or more associated users 150 and optionally executing one or more software programs 157, and/or one or more other computing systems 185 (e.g., to store and provide data, to provide supplemental computing capabilities, etc.). The one or more computing devices 190 may include any computing device or system that may receive data and/or requests, and take corresponding actions (e.g., store the data, respond to the request, etc.) as discussed herein. The earth-moving vehicle(s) 170 and/or 175 and/or 180 may correspond to various types of vehicles and have various forms, such as are illustrated in FIGS. 2A-2I.

In this example, the powered earth-moving vehicle 170-1 or 175-1 includes a variety of sensors to obtain and determine information about the powered earth-moving vehicle and its surrounding environment (e.g., a job site on which the powered earth-moving vehicle is located), including one or more GPS antennas and/or other location sensors 220, one or more inclinometers and/or other position sensors 210, one or more image sensors 250 (e.g., visible light sensors that are part of one or more cameras or other image capture devices), one or more LiDAR components 260 (e.g., with LiDAR emitters and sensors), one or more infrared sensors 265, one or more pressure sensors 215, optionally an RTK-enabled GPS positioning unit 230 that receives GPS signals from the GPS antenna(s) and RTK-based correction data from a remote base station (not shown) and optionally other data from one or more other sensors and/or devices, optionally one or more INS-DU (inertial navigation system—dual antenna) or other IMU units 285 (e.g., each using 3-axis precision magnetometers, accelerometers and gyroscopes along with GPS data, such as RTK-corrected GPS data, for high-precision position determination) or other inertial navigation systems 225, optionally one or more track or wheel alignment sensors 235, optionally one or more other sensors 245 (e.g., material analysis sensors, sensors associated with radar and/or ground-penetrating radar and/or sonar, etc.), etc. The powered earth-moving vehicle 170-1 or 175-1 may further optionally include one or more microcontrollers or other hardware CPUs 255 and/or other hardware components 270 (e.g., corresponding to some or all of the components 110, 120 and 130), such as part of a self-contained control unit that operates on the vehicle (e.g., without a cooling unit) to implement some or all of the EMVAOC system 140 (e.g., to execute some or all of the AI-assisted perception system 141; local/remote switching control module 148; planner module 147; optionally one or more other modules 149, such as including an obstacle determiner module, not shown; etc.).

As shown in FIG. 1, the powered earth-moving vehicle 170-1 or 175-1 may also include one or more physical controls 162a to enable a human operator 154 on that powered earth-moving vehicle to provide manual machine control actions via manual manipulations of the physical controls to affect movable components 174 of the powered earth-moving vehicle 170-1 or 175-1. In some implementations, the physical controls 162a include one or more of the following: one or more joysticks 164; and/or one or more pedals 166; and/or one or more buttons 168; and/or one or more other optional controls 169; etc., which provide control signals to movable components 174 of the powered earth-moving vehicle 170-1 or 175-1. The movable components 174 may include movable portions of the powered earth-moving vehicle 170-1 or 175-1, such as tracks or wheels, cab alignment positions, tool attachments (e.g., buckets), hydraulic arms (e.g., boom arms, stick arms, etc.), winches, or other parts of powered earth-moving vehicle 170-1 or 175-1 as described elsewhere herein. In some implementations, the EMVAOC system 140 may initiate and provide command signals to the components 174 to provide autonomous control of the powered earth-moving vehicle 170-1 or 175-1, such as instead of manual control by a human operator (not shown) using the physical controls 162a. As shown in FIG. 1, the powered earth-moving vehicle 170-1 or 175-1 may further include a remote control switching component 176a in communication with one or more of the physical controls 162 and/or the movable components 174. The remote control switching component 176 enables remote control switching, from a local control mode involving local autonomous control of powered earth-moving vehicle 170-1 or 175-1, to a remote control mode involving the manual control of the powered earth-moving vehicle 170-1 or 175-1 from a separate remote powered earth-moving vehicle 170-x or 175-x via corresponding control signals received over the network 195 based on a human operator (not shown) manipulating physical controls of that separate remote powered earth-moving vehicle 170-x or 175-x—similarly, a remote control switching component 176x on a remote powered earth-moving vehicle 170-x or 175-x enables receipt, after a switch from a local control mode on powered earth-moving vehicle 170-1 or 175-1 involving the manual control of powered earth-moving vehicle 170-1 or 175-1 via manual manipulation of the physical controls 162a by a human operator (not shown), to a remote control mode involving the manual control of that remote powered earth-moving vehicle 170-x or 175-x (and optionally one or more other separate powered earth-moving vehicles 170-x or 175-x) from the powered earth-moving vehicle 170-1 or 175-1 via manual manipulation of the physical controls 162a of the powered earth-moving vehicle 170-1 or 175-1 by the human operator on that vehicle 170-1 or 175-1, of corresponding control signals over the network 195 from the powered earth-moving vehicle 170-1 or 175-1. For example, a human operator can use a separate other powered earth-moving vehicle 170-x or 175-x to provide manual controls through the physical controls 162x of that other vehicle, which are then sent using the remote controls switch 176x via the network 195 to the first powered earth-moving vehicle 170-1 or 175-1, and the remote control switching component 176a of that first vehicle passes those signals to the movable components 174 of that first vehicle to enable the human operator on the other powered earth-moving vehicle to remotely control the first powered earth-moving vehicle using the physical controls 162x of that other second powered earth-moving vehicle, as described in more detail elsewhere herein. In some embodiments and situations, the remote control switches 176 and/or local/remote switching control modules 148 on two powered earth-moving vehicles may interact with each other to enable the remote takeover and control of one of those two vehicles by the other vehicle, optionally after exchanging security information to demonstrate authorization for such remote takeover and control, or otherwise determining that the remote takeover and control is authorized.

The EMVAOC system 140 obtains some or all of the data from the sensors on the powered earth-moving vehicle 170-1 or 175-1, stores the data in corresponding databases or other data storage formats on storage 120 (e.g., vehicle information 121, image data 122, LiDAR data 123, other sensor data 124, environment object (e.g., obstacle) and other mapping (e.g., terrain) data 125, etc.), optionally safety configuration data 126, and uses the data to perform automated operations involving controlling autonomous operations of the powered earth-moving vehicle 170-1 or 175-1. In this example embodiment, the EMVAOC system 140 has modules that include an AI-assisted perception system 141 (e.g., to analyze LiDAR and/or visual data of the environment to identify objects and/or determine mapping data 125 for an environment around the vehicle 170-1 and/or 175-1, such as a 3D point cloud, a terrain contour map or other visual map, etc.); a local/remote switching control module 148 (e.g., to manage how manual manipulations of physical vehicle control components of powered earth-moving vehicle 170-1 or 175-1 are handled, such as to direct corresponding control signals to a local machine interface for the powered earth-moving vehicle 170-1 or 175-1 if operating in a local control mode, or to instead direct corresponding control signals to a remote machine interface for one or more other remote powered earth-moving vehicles of the same type and/or a different type if operating in a remote control mode); a vehicle motion and part movement planner module 147 (e.g., to determine how to accomplish a goal that includes movement of one or more component parts of a vehicle, such as optionally moving the powered earth-moving vehicle from its current location to a determined target destination location and determining how to handle any possible obstacles between the current and destination locations); a system operation manager module 145 (e.g., to control overall operation of the EMVAOC system and/or the vehicle 170-1 and/or 175-1); optionally one or more other modules 149 (e.g., an obstacle determiner module to analyze information about potential obstacles in an environment of powered earth-moving vehicle 170-1 or 175-1 and determine corresponding information, such as a classification of the type of the obstacle, such as for use in generating prohibited 3D position data 127 corresponding to the obstacles); etc. Such modules may generate and use additional data as part of their operations, including for the planner module to use one or more trained vehicle behavioral models 128 as part of implementing planned vehicle motion and vehicle component part movements and generating one or more corresponding vehicle motion plans and/or vehicle component part movement plans 129 (e.g., to perform one or more tasks), and later determining and implementing one or more adaptive vehicle motion/movement plans 134 for use in addressing changing conditions while performing other operations (e.g., to adapt an original motion/movement plan 129 in use when the changing conditions occur). In addition, such modules may generate and use additional data as part of training the behavioral model(s) (e.g., using actual operational data from one or more powered earth-moving vehicles 170/175/180 and or simulated data from one or more simulator modules, not shown), etc. The modules of the EMVAOC system 140 may further optionally include one or more other modules 149 to perform additional automated operations and provide additional capabilities (e.g., analyzing and describing a job site or other surrounding environment, such as quantities and/or types and/or locations and/or activities of vehicles and/or people; one or more GUI modules, including to optionally support one or more VR (virtual reality) headsets/glasses and/or one or more AR (augmented reality) headsets/glasses and/or mixed reality headsets/glasses optionally having corresponding input controllers; etc.). In at least some embodiments, some of the EMVAOC system 140 may execute on a powered earth-moving vehicle, while other parts of the EMVAOC system 140 (e.g., the planner module 147) may execute remotely from the powered earth-moving vehicle and exchange information with the portions of the EMVAOC system 140 executing on the powered earth-moving vehicle. Additional details related to the operation of the EMVAOC system 140 are included elsewhere herein.

In this example embodiment, the one or more computing devices 190 include a copy of the EMVAOC system 140 stored in memory 130 and being executed by one or more hardware CPUs 105—software instructions of the EMVAOC system 140 may further be stored on storage 120 (e.g., for loading into memory 130 at a time of execution), but are not separately illustrated in this example. The computing device(s) 190 and EMVAOC system 140 may be implemented using a plurality of hardware components that form electronic circuits suitable for and configured to, when in combined operation, perform at least some of the techniques described herein. In the illustrated embodiment, each computing device 190 includes the one or more hardware CPUs (e.g., microprocessors), storage 120, memory 130, and various input/output (“I/O”) components 110, with the illustrated I/O components including a network connection interface 112, a computer-readable media drive 113, optionally a display 111, and other I/O devices 115 (e.g., keyboards, mice or other pointing devices, microphones, speakers, one or more VR headsets and/or glasses with corresponding input controllers, one or more AR headsets and/or glasses with corresponding input controllers, one or more mixed reality headsets and/or glasses with corresponding input controllers, etc.), although in other embodiments at least some such I/O components may not be provided (e.g., if the CPU(s) include one or more microcontrollers). The memory may further include one or more optional other executing software programs 135 (e.g., an engine to provide output to one or more VR and/or AR and/or mixed reality devices and optionally receive corresponding input). The other computing devices 155 and computing systems 185 may include hardware components similar to those of a computing device 190, but with those details being omitted for the sake of brevity.

One or more other powered earth-moving construction vehicles 170-x and/or powered earth-moving mining vehicles 175-x and/or earth-moving military vehicles 180 and/or earth-moving police vehicles 180 and/or earth-moving farming vehicles 180 may similarly be present (e.g., on the same job site as powered earth-moving vehicle 170-1 or 175-1) and include some or all such components 210-285 and/or 105-149 (although not illustrated here for the sake of brevity) and have corresponding autonomous operations controlled by the EMVAOC system 140 (e.g., with the EMVAOC system operating on a single powered earth-moving vehicle and communicating with the other powered earth-moving vehicles via wireless communications, with the EMVAOC system executing in a distributed manner on some or all of the powered earth-moving vehicles, etc.) or by another embodiment of the EMVAOC system (e.g., with each powered earth-moving vehicle having a separate copy of the EMVAOC system executing on that powered earth-moving vehicle and optionally operating in coordination with each other, etc.). The network 195 may be of one or more types (e.g., the Internet, one or more cellular telephone networks, etc.) and in some cases may be implemented or replaced by direct wireless communications between two or more devices (e.g., via Bluetooth; LoRa, or Long Range Radio; etc.). In addition, while the example of FIG. 1A includes various types of data gathered for a powered earth-moving vehicle and its surrounding environment, other embodiments may similarly gather and use other types of data, whether instead of or in addition to the illustrated types of data, including non-exclusive examples of image data in one or more non-visible light spectrums (e.g., infrared, ultraviolet, radiation, etc.), other energy data (e.g., sound, radiation, etc.), location data of types other than from satellite-based navigation systems, depth or distance data to an object, color data, etc. In addition, in some embodiments and situations, different devices and/or sensors may be used to acquire the same or overlapping types of data (e.g., simultaneously), and the EMVAOC system may combine or otherwise use such different types of data, including to determine differential information for a type of data.

FIG. 1B illustrates example modules and interactions used to implement autonomous operations of one or more powered earth-moving vehicles on a site, such as to provide an overview of a software and/or hardware architecture used for performing at least some of the described techniques in at least some embodiments. In particular, FIG. 1B illustrates information 191b that includes a hardware layer associated with one or more types of powered earth-moving vehicles 170 and/or powered earth-moving mining vehicles 175 and/or powered earth-moving vehicles 180 (e.g., corresponding to components 210-285 of FIG. 1A), such as to receive instructions about controlling autonomous operation of the earth-moving vehicle(s) 170/175/180, and to perform actions that include actuation (e.g., translating digital actions into low-level hydraulic impulses, including in some embodiments to use one or more piston displacement mechanisms located on a powered earth-moving vehicle 170/175/180 and positioned to manipulate one or more controls of the powered earth-moving vehicle when actuated, such as one or more joystick controls, pedal controls, button controls, etc.), sensing (e.g., to manage sensor readings and data logging), safety (e.g., to perform redundant safety independent of higher-level perception operations), etc. In the illustrated example, the hardware layer interacts with or as part of a perception module, such as to use one or more sensor types to obtain data about the earth-moving vehicle(s) and/or their environment (e.g., LiDAR data, radar data, visual data from one or more RGB camera devices, infrared data from one or more IR sensors, ground-penetrating radar data, sound data, etc.). The perception module and/or hardware layer may further interact with a unified interface that connects various modules, such as to operate a network layer and to be implemented in protocol buffers as part of providing a module communication layer, as well as to perform data logging, end-to-end testing, etc. In the illustrated example, the unified interface further interacts with an AI (artificial intelligence) module (e.g., that includes the EMVAOC system 140), a GUI module, a Planner module, a Global 3D Mapping module, one or more Sim simulation modules (e.g., operational data simulator modules that are part of the EMVAOC system 140), and one or more other modules to perform data analytics and visualization. In this example, the AI module provides functionality corresponding to machine control, decision-making, continuous learning, etc. The GUI module performs activities that include providing information of various types to users (e.g., from the EMVAOC system) and manually receiving information (e.g., to be provided to the EMVAOC system, to add tasks to be performed, to merge a site scan with a site plan, etc.). The Planner module performs operations that may include computing an optimal plan for an entire job (e.g., with various tasks to be performed in sequence and/or serially), and the Global 3D Mapping module performs activities that may include providing a description of a current state and/or desired state of an environment around the earth-moving vehicle(s), performing global site mapping merging (e.g., using DigMaps across earth-moving vehicles on the site and optionally drones, such as terrain height and shape), etc. The one or more Sim modules perform simulations to provide data from simulated operation of the one or more earth-moving vehicles, such as for use in AI control, machine learning neural network training (e.g., for one or more behavioral models), replaying logs, planning visualizations, etc. It will be appreciated that the EMVAOC system may be implemented in other architectures and environments in other embodiments, and that the details of FIG. 1B are provided for illustrative purposes. In addition, while not illustrated in FIG. 1B, in some embodiments one or more specialized versions of the EMVAOC system may be used for particular types of powered earth-moving vehicles, with non-exclusive examples including the following: an Excavator Motion/Movement Control (EMC) system to control motion/movement of one or more excavator vehicles; an Excavator X Motion/Movement Control (EMC-X) system to similarly control a particular construction and/or mining excavator X vehicle; a Dump Truck Motion/Movement Control (DTMC) system to control motion/movement of one or more types of construction and/or mining dump truck vehicles; a Dump Truck X Motion/Movement Control (DTMC-X) system to similarly control a particular construction and/or mining dump truck X vehicle; a Wheel Loader Motion/Movement Control (WLMC) system to control motion/movement of one or more types of construction and/or mining wheel loader vehicles; a Wheel Loader X Motion/Movement Control (WLMC-X) system to similarly control a particular construction and/or mining wheel loader X vehicle; one or more other motion/movement control systems specific to particular types of construction and/or mining vehicles other than excavators and dump trucks and wheel loaders; a Construction Vehicle Motion/Movement Control (CVMC) system to control some or all types of powered earth-moving construction vehicles; a Mining Vehicle Motion/Movement Control (MVMC) system to control some or all types of powered earth-moving mining vehicles; etc.

FIG. 1C illustrates information 191c that includes an example worksite 101 at which at least some powered earth-moving vehicles may perform operations via autonomous control, and at which a selected one of those autonomously controlled powered earth-moving vehicle may be remotely switched to manual control of its ongoing operations from another powered earth-moving vehicle on the worksite. As shown in FIG. 1C, powered earth-moving vehicles 170-1 and/or 175-1 are depicted in this example as powered earth-moving vehicles 199 of one or more vehicle types that may be moving about a worksite 101 and performing various operations (not shown). In this example, a first powered earth-moving vehicle 199a includes a human operator 154 performing manual control of that vehicle 199a, while powered earth-moving vehicles 199b-199e are initially implementing operations via autonomous control without human involvement. In some implementations, the human operator 154 may opt to initiate remote control of one or more selected vehicles of the vehicles 199b-199e from the powered earth-moving vehicle 199a (e.g., for one or more vehicles 199b-e of a same vehicle type as that of vehicle 199a), such as in situations in which the autonomous control of the selected vehicle(s) is unable to perform operations that satisfy one or more defined criteria (e.g., cannot determine instructions to perform, cannot proceed in light of defined safety constraints, etc., such as when the selected vehicle(s) are in an edge case situation for which their vehicle behavioral model(s) 128 have not been sufficiently trained or if a next action has not been determined by the planner module 147, etc.). As shown, the human operator 154 may use the first vehicle 199a as a remote control unit to manually control operation of one or more (e.g., multiple) of the other vehicles 199b-199e that are selected, such as selected vehicle 199b in this example, via a remote control switching component 176a of the powered earth-moving vehicle 199a that receives input manipulations of the physical controls of the first vehicle 199a and transmits corresponding control instruction signals 197a to a second selected vehicle (e.g., vehicle 199b), with the second selected vehicle having a second remote control switching component 176b that receives and passes the input manipulation control instruction signals to the movable components of the second selected vehicle and optionally transmits back feedback 198a from the vehicle 199b (e.g., input to sensors of the vehicle 199b, such as one or more cameras and/or other perception sensors, sensors associated with movable components of the vehicle 199b and/or other vehicle status sensors, etc.). In this manner, the human operator 154 may remotely control the second selected powered earth-moving vehicle 199b from the first powered earth-moving vehicle 199a by manually using the physical controls of the first vehicle to virtually and remotely control the movable components of the second selected vehicle 199b. In this example, the human operator 154 may further select to return the second selected vehicle 199b to autonomous control at a later time (e.g., after completing one or more operations) and opt to serially connect to and control one or more other powered earth-moving vehicles on the site (e.g., powered earth-moving vehicles 199c and/or 199d and/or 199e), while in other embodiments and situations the remote control may be performed in other manners (e.g., to simultaneously control multiple other powered earth-moving vehicles of a same type as the powered earth-moving whose physical controls are being used by the human operator, such as to simultaneously perform the same operations on each of those multiple other powered earth-moving vehicles; to control another powered earth-moving vehicle of a different type than the powered earth-moving vehicle whose physical controls are being used by the human operator, such as to use physical controls common to both vehicle types and/or to map some or all physical control inputs on a first powered earth-moving vehicle to different types of physical controls on a second powered earth-moving vehicle being controlled, such as for different types of tool attachments and/or other vehicle movable components being controlled; to control one or more other powered earth-moving vehicles of the same and/or different vehicle type that are located on a remote worksite; etc.).

In some implementations, this remote control switching may be performed in situations in which the human operator 154 from the first powered earth-moving vehicle 199a can see the remote controlled vehicle (e.g., vehicle 199b) that is being controlled remotely and/or its environment, and the human operator 154 controls the remote vehicle based in part or in whole on that visual vantage point of the human operator 154 from the vehicle 199a. In further implementations, the vehicle 199a may include one or more displays 111 (not shown) that receive and display data from sensors on the remote vehicle being controlled (e.g., vehicle 199b), such as visual data from image sensors 250 (e.g., cameras) and/or LiDAR data from LiDAR components 260, data from infrared sensors 265, and/or data from the other sensors of the remote vehicle being controlled, which enables the human operator 154 to view the environment and operating conditions of that remote vehicle being controlled and to enable the human operator to remotely provide the manipulations of the physical controls to the vehicle 199b based in part or in whole on that displayed data. For example, if vehicle 199b gets stuck in an unexpected situation, the human operator 154 may be able to remotely takeover control of vehicle 199b (e.g., via input from the human operator 154 that is provided on the vehicle 199a to select that vehicle 199b and to initiate remote control of it, via a request sent to the vehicle 199a from the EMVAOC system on the vehicle 199b and/or from another source, etc.) and perform operations to manipulate the vehicle 199b (e.g., to manually perform a task, to move the vehicle 199b to a new location from which the vehicle 199b may continue autonomous operations, to otherwise ‘unstick’ the vehicle 199b, etc.) by using the remote control switching component 176a of vehicle 199a to pass the physical control input manipulations provided manually at the vehicle 199a to the movable components of vehicle 199b.

Using the remote control switching component 176a of the powered earth-moving vehicle 199a to toggle between manual control of the local vehicle 199a on which the human operator 154 is located and remote control of a separate vehicle (e.g., vehicle 199b), a local human operator 154 of the local vehicle 199a is enabled to control other vehicles (e.g., any equivalent vehicle of the same or similar type on a common worksite 101) as if the human operator user is sitting inside another such controlled vehicle, while actually being in a different vehicle used as a control unit from which to manually provide control signals. The local human operator 154 can also then seamlessly transition from remote control of the separate remote vehicle back to manual control of the local vehicle in which they reside, such as to allow the separate remote vehicle to resume autonomous control. This enables the local human operator 154 to control a separate vehicle (e.g., of a same or similar vehicle type, such as the same make and model, and/or equipped with the same tool attachments and/or other optional equipment, etc.) without a simulated remote control system that lacks exact replication of the actual vehicle controls, with the human operator 154 instead using the actual controls of the local powered earth-moving vehicle that is virtually and remotely connected temporarily to that separate remote vehicle and/or to any other vehicles on the worksite 101 (or in some embodiments and situations on one or more other remote worksites).

In some implementations, the remote control switching components 176 on the local powered earth-moving vehicle and on the separate powered earth-moving vehicle being controlled may each be a physical hardware component that interrupts the signals between the physical controls 162 of that vehicle and the movable components 174 of that vehicle, and instead diverts and transmits the signals to one or more separate remote controls switch(s) 176 for further forwarding or handling. In further implementations, some or all remote control switching components 176 may instead be implemented in software in part or in whole and reside within the EMVAOC system 140 (e.g., as part of module 148) and participate as part of the autonomous control of the vehicle, such as to control when control signals are sent to the local movable components 174 in a local control mode and when to transmit them to a separate remote vehicle to provide to its movable components 174 in a remote control mode (e.g., in response to input from a human operator as to select which control mode to use). In some implementations, the modules of the EMVAOC system 140 executing on a powered earth-moving vehicle may observe any remote control signals provided to the vehicle from one or more remote vehicles and use the control signals in manners other than control of the powered earth-moving vehicle (e.g., in addition to using them for control of the powered earth-moving vehicle), such as to update one or more behavioral models of that EMVAOC system (e.g., to refine the autonomous controls and/or unlock full shifts faster).

In addition, the transmission of data (e.g., control signals, sensor readings, security information, etc.) between a local powered earth-moving vehicle and a separate remote powered earth-moving vehicle being controlled by it may occur in various manners in various embodiments and situations. As one example, information 191c includes an example communication scenario 191c1 illustrating a centralized star network architecture in which transmissions to and from the various powered earth-moving vehicles 199 (shown as solid lines with arrows indicate the direction of transmissions) pass through one or more centralized server computing systems or other devices 185, with example control instructions 197b from a local powered earth-moving vehicle (e.g., vehicle 199a) passing through the centralized device(s) 185 to a separate powered earth-moving vehicle being remotely controlled (e.g., vehicle 199c), and with optional feedback 198b from the separate vehicle similarly passing through the centralized device(s) 185 to the local vehicle. As another example, information 191c includes an example communication scenario 191c5 illustrating centralized communications passing through one of the powered earth-moving vehicles (e.g., vehicle 199e) to one or more of the other vehicles on the same site (e.g., vehicles 199a-199d), such that the central vehicle 199e may serially and/or concurrently remotely control any of the other vehicles, such as via example control instructions 197c1 to and corresponding optional feedback 198c1 from remote vehicle 199c being controlled, via example control instructions 197c2 to and corresponding optional feedback 198c2 from remote vehicle 199d being controlled, etc. As yet another example, information 191c includes an example communication scenario 191c2 illustrating a decentralized communications architecture in which different devices may participate in different subnetworks or other inter-vehicle communications, such as devices 199a and 199b and 199d forming a first fully connected network 195a between each other and device(s) 185, devices 199b and 199c and 199d forming a second network 195b with device 199d acting as a centralized device through which transmissions between devices 199b and 199c pass, devices 199a and 199c forming third direct transmissions 195c between the devices, etc.—while particular example control instructions 197 and optional resulting feedback 198 are not shown in this example, any two vehicles in communication may act as a control pair in which one of the vehicles of the pair remotely controls the operations of the other vehicle of the pair. As yet another example, information 191c includes an example communication scenario 191c3 illustrating peer-to-peer communications architecture in which different pairs of devices communicate directly with each other, such as direct communications 196a between vehicles 199a and 199b, direct communications 196b between vehicles 199b and 199d, etc.—any pair of two such vehicles in communication may enable one of the vehicles of the pair to remotely control the operations of the other vehicle of the pair, such as via control instructions 197e and resulting optional feedback 198e between vehicles 199a and 199b. As yet another example, information 191c includes an example communication scenario 191c4 illustrating a mesh network architecture in which the vehicles 199a-199e communicate with each other via direct connections between at least some vehicles—in a similar manner to the other example network scenarios, any two vehicles in communication may act as a control pair in which one of the vehicles of the pair remotely controls the operations of the other vehicle of the pair, such as via control instructions 197f and resulting optional feedback 198f between vehicles 199c and 199e (which in this example physically pass through at least intermediate vehicle 199a). As yet another example, information 191c includes an example communication scenario 191c6 illustrating a ring network architecture in which the vehicles 199a-199e communicate with each other via direct connections between pairs of vehicles—in a similar manner to the other example network scenarios, any two vehicles in communication may act as a control pair in which one of the vehicles of the pair remotely controls the operations of the other vehicle of the pair, such as via control instructions 197g and resulting optional feedback 198g between vehicles 199a and 199d (which in this example physically pass through intermediate vehicle 199b and/or through intermediate vehicles 199c and 199e). Other network architectures and inter-vehicle communication types may be used in other embodiments and situations, and as discussed in greater detail elsewhere herein, transmissions may be sent using various communication protocols in various embodiments and situations, such as Bluetooth, LoRa (Long Range Radio, Wi-Fi, cellular transmissions, etc.

It will be appreciated that computing devices, computing systems and other equipment (e.g., powered earth-moving vehicle(s) included within FIGS. 1A-1C are merely illustrative and are not intended to limit the scope of the present invention. The systems and/or devices may instead each include multiple interacting computing systems or devices, and may be connected to other devices that are not specifically illustrated, including via Bluetooth communication or other direct communication, a mesh network, through one or more networks such as the Internet, via the Web, or via one or more private networks (e.g., mobile communication networks, etc.). More generally, a device or other system may comprise any combination of hardware that may interact and perform the described types of functionality, optionally when programmed or otherwise configured with particular software instructions and/or data structures, including without limitation desktop or other computers (e.g., tablets, slates, etc.), database servers, network storage devices and other network devices, smart phones and other cell phones, consumer electronics, wearable devices, digital music player devices, handheld gaming devices, PDAs, wireless phones, Internet appliances, camera devices and accessories, and various other consumer products that include appropriate communication capabilities. In addition, the functionality provided by the illustrated EMVAOC system 140 may in some embodiments be distributed in various modules, some of the described functionality of the EMVAOC system 140 may not be provided, and/or other additional functionality may be provided.

It will also be appreciated that, while various items are illustrated as being stored in memory or on storage while being used, these items or portions of them may be transferred between memory and other storage devices for purposes of memory management and data integrity. Alternatively, in other embodiments some or all of the software modules and/or systems may execute in memory on another device and communicate with the illustrated computing systems via inter-computer communication. Thus, in some embodiments, some or all of the described techniques may be performed by hardware means that include one or more processors and/or memory and/or storage when configured by one or more software programs (e.g., by the EMVAOC system 140 executing on computing device(s) 190) and/or data structures (e.g., in databases 121-129 and 134), such as by execution of software instructions of the one or more software programs and/or by storage of such software instructions and/or data structures, and such as to perform algorithms as described in the flow charts and other disclosure herein. Furthermore, in some embodiments, some or all of the systems and/or modules may be implemented or provided in other manners, such as by consisting of one or more means that are implemented partially or fully in firmware and/or hardware (e.g., rather than as a means implemented in whole or in part by software instructions that configure a particular CPU or other processor), including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored as contents (e.g., as software instructions or structured data) on a non-transitory computer-readable storage mediums, such as a hard disk or flash drive or other non-volatile storage device, volatile or non-volatile memory (e.g., RAM or flash RAM), a network storage device, or a portable media article (e.g., a DVD disk, a CD disk, an optical disk, a flash memory device, etc.) to be read by an appropriate drive or via an appropriate connection. The systems, modules and data structures may also in some embodiments be transmitted via generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of the present disclosure may be practiced with other computer system configurations.

As noted above, in at least some embodiments, data may be obtained and used by the EMVAOC system from sensors of multiple types that are positioned on or near one or more powered earth-moving vehicles, such as one or more of the following: GPS data or other location data; inclinometer data or other position data for particular movable component parts of an earth-moving vehicle (e.g., a digging arm/tool attachment of an earth-moving vehicle); real-time kinematic (RTK) positioning information based on GPS data and/or other positioning data that is corrected using RTK-based GPS correction data transmitted via signals from a base station (e.g., at a location remote from the site at which the vehicle is located); track and cabin heading data; visual data of captured image(s) using visible light; depth data from depth-sensing and proximity devices such as LiDAR (e.g., depth and position data for points visible from the LiDAR sensors, such as three-dimensional, or “3D”, points corresponding to surfaces of terrain and objects) and/or other than LiDAR (e.g., ground-penetrating radar, above-ground radar, other laser rangefinding techniques, synthetic aperture radar or other types of radar, sonar, structured light, etc.); infrared data from infrared sensors; material type data for loads and/or a surrounding environment from material analysis sensors; load weight data from pressure sensors; etc. As one non-exclusive example, the described systems and techniques may in some embodiments include obtaining and integrating data from sensors of multiple types positioned on a powered earth-moving vehicle at a site, and using the data to determine and control operations of the vehicle to accomplish one or more defined tasks at the site (e.g., dig a hole of a specified size and/or shape and/or at a specified location, move one or more rocks from a specified area, extract a specified amount of one or more materials, remove hazardous or toxic material from above ground and/or underground, perform trenching, perform demining, perform breaching, etc.), including determining current location and positioning of the vehicle on the site, determining and implementing movement around the site, determining and implementing operations involving use of the vehicle's tool attachment(s) and/or arms (e.g., hydraulic arms), etc. Such powered earth-moving construction vehicles (e.g., one or more tracked or wheeled excavators, bulldozers, tracked or wheeled skid loaders or other loaders such as front loaders and backhoe loaders, graders, cranes, compactors, conveyors, dump trucks or other trucks, deep sea construction machinery, extra-terrestrial construction machinery, etc.) and powered earth-moving mining vehicles (e.g., one or more tracked or wheeled excavators, bulldozers, tracked or wheeled skid loaders and other loaders such as front loaders and backhoe loaders, scrapers, graders, cranes, trenchers, dump trucks or other trucks, deep sea mining machinery, extra-terrestrial mining machinery, etc.) are referred to generally as ‘earth-moving vehicles’ herein, and while some illustrative examples are discussed below with respect to controlling one or more particular types of vehicles (e.g., excavator vehicles, wheel loaders or other loader vehicles, dump truck or other truck vehicles, etc.), it will be appreciated that the same or similar techniques may be used to control one or more other types of powered earth-moving vehicles (e.g., vehicles used by military and/or police for operations such as breaching, demining, etc., including demining plows, breaching vehicles, etc.). With respect to sensor types, one or more types of GPS antennas and associated components may be used to determine and provide GPS data in at least some embodiments, with one non-exclusive example being a Taoglas MagmaX2 AA.175 GPS antenna. In addition, one or more types of LiDAR devices may be used in at least some embodiments to determine and provide depth data about an environment around an earth-moving vehicle (e.g., to determine a 3D, or three-dimensional, model of some or all of a job site on which the vehicle is situated), with non-exclusive examples including LiDAR sensors of one or more types from Livox Tech. (e.g., Mid-70, Avia, Horizon, Tele-15, Mid-40, Mid-100, HAP, etc.) and with corresponding data optionally stored using Livox's LVX point cloud file format v1.1, LiDAR sensors of one or more types from Ouster Inc. (e.g., OS0 and/or OS1 and/or OS2 sensors), etc.—in some embodiments, other types of depth-sensing and/or 3D modeling techniques may be used, whether in addition to or instead of LiDAR, such as using other laser rangefinding techniques, synthetic aperture radar or other types of radar, sonar, image-based analyses (e.g., SLAM, SfM, etc.), structured light, etc. Furthermore, one or more proximity sensor devices may be used to determine and provide short-distance proximity data in at least some embodiments, with one non-exclusive example being an LJ12A3-4-Z/BX inductive proximity sensor from ETT Co., Ltd. Moreover, real-time kinematic positioning information may be determined from a combination of GPS data and other positioning data, with one non-exclusive example including use of a u-blox ZED-F9P multi-band GNSS (global navigation satellite system) RTK positioning component that receives and uses GPS, GLONASS, Galileo and BeiDou data, such as in combination with an inertial navigation system (with one non-exclusive example including use of MINS300 by BW Sensing) and/or a radio that receives RTK correction data (e.g., a Digi XBee SX 868 RF module, Digi XBee SX 900 RF module, etc.). Other hardware components that may be positioned on or near an earth-moving vehicle and used to provide data and/or functionality used by the EMVAOC system include the following: one or more inclinometers (e.g., single axis and/or double axis) or other accelerometers (with one non-exclusive example including use of an inclination sensor by DIS sensors, such as the QG76 series); a CAN bus message transceiver (e.g., a TCAN 334 transceiver with CAN flexible data rate); one or more low-power microcontrollers (e.g., an i.MX RT1060 Arm-based Crossover MCU microprocessor from NXP Semiconductors; an ARM Cortex-M7 at 600 MHz, whether operating on its own or present on a PJRC Teensy 4.1 Development Board; a Grove 12-bit Magnetic Rotary Position Sensor AS5600, etc.) or other hardware processors, such as to execute and use executable software instructions and associated data of the EMVAOC system; one or more voltage converters and/or regulators (e.g., an ST LT1576 or LD1117 or LM217 or LM317 adjustable voltage regulator, etc.); a voltage level shifter (e.g., using a field effect transistor, such as a Fairchild Semiconductor BSS138 N-Channel Logic Level Enhancement Mode Field Effect Transistor); etc. In addition, in at least some embodiments and situations, one or more types of data from one or more sensors positioned on an earth-moving vehicle may be combined with one or more types of data (whether the same types of data and/or other types of data) acquired from one or more positions remote from the earth-moving vehicle (e.g., from an overhead location, such as from a drone aircraft, an airplane, a satellite, etc.; elsewhere on a site on which the earth-moving vehicle is located, such as at a fixed location and/or on another earth-moving vehicle of the same or different type; etc.), with the combination of data used in one or more types of autonomous operations as discussed herein. Additional details are included below regarding positioning of data sensors and use of corresponding data, including with respect to the examples of FIGS. 2A-2I.

As is also noted above, automated operations of an EMVAOC system may include determining current location and other positioning of a powered earth-moving vehicle on a site in at least some embodiments. As one non-exclusive example, such position determination may include using one or more track sensors to monitor whether or not a vehicle's tracks are aligned in the same direction as the vehicle's cabin and/or body, and using GPS data (e.g., from 3 GPS antennas located on the vehicle's cabin and/or body, such as in a manner similar to that described with respect to FIGS. 2A-2I) optionally in conjunction with an inertial navigation system to determine the rotation of the cabin and/or body (e.g., relative to true north). When using data from multiple GPS antennas, the data may be integrated in various manners, such as by using a microcontroller located on the powered earth-moving vehicle, and with additional RTK (real-time kinetic) positioning data optionally used to reinforce and provide further precision with respect to the GPS-based location (e.g., to achieve 1-inch precision or better). In addition, in some embodiments and situations, LiDAR data is used to assist in position determination operations, such as by surveying the surrounding environment around the powered earth-moving vehicle (e.g., some or all of a job site on which the powered earth-moving vehicle is located, such as terrain of the job site and objects on the job site) and confirming a current location of the powered earth-moving vehicle in two-dimensional (“2D”) and/or three-dimensional (“3D”) space, whether an absolute location (e.g., using GPS locations) and/or a relative location (e.g., using the vehicle or other element as a center point relative to which other points are mapped), and in some cases relative to a 2D and/or 3D map of the job site generated from the LiDAR data and/or from analysis of visual data of images (e.g., a 3D point cloud having a plurality of data points each with an associated position in 3D space and representing a point on a surface, such as the ground or other terrain, an obstacle or other object above the ground, etc.; other types of 3D representations, such as meshes, planar surfaces or other types of surfaces, parametric models, depth-maps, RGB-D, voxels, etc.; 2D point clouds and/or other 2D representations; etc.). Additional details are included below regarding such automated operations to determine current location and other positioning of a powered earth-moving vehicle on a site.

In addition, automated operations of an EMVAOC system may further include determining a target destination location and/or path of a powered earth-moving vehicle on a job site or other geographical area. For example, one or more planner modules of the EMVAOC system determines a current target destination location and/or path of a powered earth-moving vehicle (e.g., in accordance with other goals or planning operations being performed by the EMVAOC system, such as based on an overall analysis of a site and/or as part of accomplishing a group of multiple activities at the site). In addition, the motion of the powered earth-moving vehicle from a current location to a target destination location or otherwise along a determined path may be initiated in various manners, such as by an operator module of the EMVAOC system that acts in coordination with the one or more planner modules (e.g., based on a planner module providing instructions to the operator module about current work to be performed, such as work for a current day that involves the powered earth-moving vehicle leaving a current work area and moving to a new area to work), or directly by a planner module (e.g., to move to a new location along a track to perform terrain leveling and/or to prepare for digging). In other embodiments, determination of a target destination location and/or path and initiation of powered earth-moving vehicle motion may be performed in other manners, such as in part or in whole based on input received from one or more human users or other sources. Additional details are included below regarding such automated operations to determine a target destination location and/or path of a powered earth-moving vehicle on a site.

In addition, while the autonomous operations of a powered earth-moving vehicle controlled by the EMVAOC system may in some embodiments be fully autonomous and performed without any input or intervention of any human users (e.g., fully implemented by an embodiment of the EMVAOC system executing on that powered earth-moving vehicle without receiving human input and without receiving external signals other than possibly one or more of GPS signals and RTK correction signals), in other embodiments the autonomous operations of a powered earth-moving vehicle controlled by the EMVAOC system may include providing information to one or more human users about the operations of the EMVAOC system and optionally receiving information from one or more such human users (whether on-site or remote from the site) that are used as part of the automated operations of the EMVAOC system (e.g., a target destination location, a high-level work plan, etc.), such as via one or more GUIs (“graphical user interfaces”) displayed on one or more computing device that provide user-selectable controls and other options to allow a user to interactively request or specify types of information to display and/or to interactively provide information for use by the EMVAOC system.

FIGS. 2A-2I illustrate examples of earth-moving vehicles and types of on-vehicle data sensors positioned to support autonomous operations on a site and allow for remote control switching as described elsewhere herein.

In particular, with respect to FIG. 2A, information 290a about an example powered earth-moving construction vehicle 170a and/or mining vehicle 175a is illustrated, which in this example is a tracked excavator vehicle with components, using an upper-side-frontal view from the side of the digging boom arm (or ‘boom’) 206 and stick arm (or ‘stick’) 204 and opposite the side of the cabin 202, with the earth-moving vehicle 170a/175a further having a main body 201 (e.g., enclosing an counterweight 221 and engine, and including the cabin 202) of the chassis, tracks 203 and bucket (or ‘scoop’ or ‘claw’) tool attachment 209a—in other embodiments, other types of digging arm tool attachments may be used such as, for example, a hydraulic thumb, coupler, breaker, compactor, digging bucket, grading bucket, hammer, demolition grapple, tiltrotator, etc. Four example inclinometers 210 are further illustrated at positions that beneficially provide inclinometer data to compute the position of the bucket and other parts of the digging arms relative to the position of the cabin of the earth-moving vehicle. In this example, three inclinometers 210a-210c are mounted at respective positions on the digging arms of the earth-moving vehicle (position 210c near the intersection of the digging boom arm and the body of the earth-moving vehicle, position 210b near the intersection of the digging stick arm and the bucket attachment, and position 210a near the intersection of the digging boom and stick arms), such as to use single-axis inclinometers in this example, and with a fourth inclinometer 210d mounted within the cabin of the earth-moving vehicle and illustrated at an approximate position using a dashed line, such as to use a dual-axis inclinometer that measures pitch and roll angles—data from the inclinometers may be used, for example, to track the position of the earth-moving vehicle arms/attachment, including when a track heading direction 207 is determined to be different (not shown in this example) from a cabin/body heading direction 208. This example illustrates a position of one or more pressure sensors 215, which in this example are positioned along one or more pressure pipes (not shown) connected to the bottom of one or more pistons (or ‘cylinders’) configured to raise and lower the digging boom arm 206. This example further illustrates a position of a LiDAR component 260, which in this example is positioned on the underside of the digging boom arm 206 near its bend in the middle, and as such is movable along with the movements of the digging boon arm 206, as well as in some embodiments being independently movable (e.g., to rotate, tilt, swivel, etc.)—in other embodiments, the LiDAR component 260 may be located in other positions on the vehicle 170a/175a and/or may be one of multiple LiDAR components positioned at different locations on the vehicle. The vehicle may further have one or more INS-DU or other IMU units, which are not shown in this example. It will be appreciated that other quantities, positionings and types of illustrated sensors/components may be used in other embodiments.

FIGS. 2B and 2C continue the example of FIG. 2A, and illustrate information 290b and 290c, respectively, about three example GPS antennas 220 at positions that beneficially provide GPS data to assist in determining the positioning and direction of the cabin/body of the earth-moving vehicle 170a/175a, including to use data from the three GPS antennas to provide greater precision than is available from a single GPS antenna. In this example, the three GPS antennas 220a-220c are positioned on the earth-moving vehicle body and proximate to three corners of the body (e.g., as far apart from each other as possible), such that differential information between GPS antennas 220a and 220c may provide cabin heading direction information, and differential information between GPS antennas 220b and 220c may provide lateral direction information at approximately 90° from that cabin heading direction information. In particular, in FIG. 2B, the example earth-moving vehicle is shown using a side-rear view from the side of the arms, with GPS antennas 220b and 220c illustrated on the back of the body at or below the top of that portion of the body, and with an approximate position of GPS antenna 220a on the cabin top near the front illustrated with dashed lines (e.g., as illustrated further in FIG. 2C). FIG. 2B further illustrates the counterweight 221 at the back of the body, and illustrates a center of gravity 222 of the vehicle that moves forward and backward as the arms and attachment are moved while the cabin/chassis is aligned with the tracks, and may move in other directions as the cabin/chassis rotates and/or as the arms and attachment are moved while the cabin/chassis is not aligned with the tracks (not shown). In FIG. 2C, the example earth-moving vehicle is shown using an upper-side-frontal view from the side of the cabin, with GPS antenna 220a shown on the cabin top near the front on the same side as GPS antenna 220c, and with the positions of GPS antennas 220b and 220c illustrated through the body with dashed lines (e.g., just below the top of the back of the body, as illustrated in FIG. 2B). While not illustrated in FIGS. 2B-2C, some or all of the GPS antennas may be enabled to receive and use RTK data to further improve the accuracy of the GPS signals that are produced, such as by each being part of or otherwise associated with a GPS receiver including an RTK radio that receives and uses RTK-based GPS correction data transmitted from a base station (e.g., at a location remote from the site at which the earth-moving vehicle is located) to improve accuracy of the GPS signals from the GPS antennas, so as to be part of one or more RTK-enabled GPS positioning units. The LiDAR component 260 and pressure sensor 215 are also illustrated, using dashed lines in FIG. 2B to indicate the location on the underside of the digging boom arm (for the LiDAR component) and bottom of the piston(s) (for the one or more pressure sensors) due to the boom arm blocking a direct view of the component 260, and being directly visible in FIG. 2C. FIG. 2C also illustrates possible locations of one or more RGB cameras 250 with image sensors (not shown separately) that gather additional visual data about an environment of the vehicle 170a/175a from visible light—in this example, four cameras are used on top of the cabin (e.g., to in the aggregate provide visual coverage of some or all of 360° horizontally), with two on each side, and optionally with the two front camera facing partially or fully forwards and the two back cameras facing partially or fully backwards, although in other embodiments other camera configurations and/or types may be used (e.g., one or more cameras with panoramic view angles, such as to each cover some or all of 360° horizontally). In at least some embodiments and situations, some or all such cameras may be independently movable (e.g., to rotate, tilt, swivel, etc.) at their positions, and may further in at least some such embodiments be positioned on one or more movable component parts of the vehicle (e.g., a hydraulic arm, attachment, etc.). In addition, in some embodiments and situations, the camera positioning may include having one or two forward-facing cameras (e.g., cameras that each produces perspective rectilinear images and/or video with a standard field of view and that in aggregate cover all or substantially all of the front area around the vehicle, such as all but a small area blocked by a front attachment of the vehicle), and one or two backward-facing camera (e.g., cameras that each produces panoramic images and/or video with a wide-angle field of view of 120° or 150° or 180° or more that covers the back and optionally some or all of the sides of vehicle). It will be appreciated that other quantities, positionings and types of GPS antennas (and/or antennas for other types of satellite-based navigation systems) and/or other sensors/components may be used in other embodiments.

FIGS. 2D-2I continue the examples of FIGS. 2A-2C, with FIGS. 2D and 2E illustrating further example details about another earth-moving construction vehicle 170c and/or mining vehicle 175c, which in this example is a bulldozer vehicle having a blade attachment 211d (although other tool attachments may be used in other embodiments), such as to illustrate example positions for GPS receivers 220 and/or inclinometers 210 and/or one or more LiDAR components 260 and/or one or more cameras 250 and/or one or more pressure sensors 215. In particular, FIG. 2D illustrates example information 290d that includes various example inclinometers 210e-210i, example GPS antennas/receivers 220d-220f, and possible locations for one or more LiDAR components 260 and one or more pressure sensors 215. The example inclinometers 210e-210i are illustrated at positions that beneficially provide inclinometer data to compute the location of the blade or other front attachment (and optionally other parts of the bulldozer, such as the hydraulic arms) relative to the cabin of the bulldozer vehicle (e.g., at position 210e near the intersection of the track spring lifting arm and the body of the vehicle, position 210f near the intersection of the track spring lifting arm and the blade or other attachment, position 210g at one end of a hydraulic arm, position 210h at one end of the tilt cylinder, etc.), such as to use single-axis inclinometers in this example, and with another inclinometer 210i mounted within the cabin of the vehicle and illustrated at an approximate position using a dashed line, such as to use a dual-axis inclinometer that measures pitch and roll-data from the inclinometers may be used, for example, to track the position of the track spring lifting arm and attachment relative to the cabin/body of the vehicle. The example GPS antennas/receivers 220 are illustrated at positions that beneficially provide GPS data to assist in determining the positioning and direction of the cabin/body, including to use data from the three GPS antennas to provide greater precision than is available from a single GPS antenna. In this example, the three GPS antennas 220d-220f are positioned on the body and proximate to three corners of the body (e.g., as far apart from each other as possible), such that differential information between GPS antennas 220f and 220e may provide cabin heading direction information, and differential information between GPS antennas 220d and 220e may provide lateral direction information at approximately 90° from that cabin heading direction information. The example one or more LiDAR components 260 are illustrated at one or more possible positions that beneficially provide LiDAR data about some or all of an environment around the vehicle 170c/175c, such as to be positioned on one or more sides of the blade/scoop attachment (e.g., to have a view to the side(s) of the vehicle) and/or a top or bottom (not shown) of the blade/scoop attachment (e.g., to have a view forwards), and/or on sides of one or more of the hydraulic arms (e.g., to have a view to the side(s) of the vehicle), and/or on a front of the body (e.g., near the top to have a view forwards over the blade/scoop attachment), etc. The example one or more pressure sensors 215 are illustrated at one or more possible positions to connect to pressure pipes (not shown) at the bottom of one or more pistons controlling movement of the attachment. FIG. 2E also illustrates possible locations of one or more RGB cameras 250 that gather additional visual data about an environment of the vehicle 170c/175c—in this example, four cameras are used on top of the cabin (e.g., to in the aggregate provide visual coverage of some or all of 360° horizontally), with two on each side, and optionally with the two front camera facing partially or fully forwards and the two back cameras facing partially or fully backwards, although in other embodiments other camera configurations and/or types may be used (e.g., one or more cameras with panoramic view angles, such as to each cover some or all of 360° horizontally). In particular, in FIG. 2D, the example earth-moving vehicle is shown using a side view, with GPS antennas 220d and 220e illustrated on the back of the body at or below the top of that portion of the body (using dashed lines to illustrate position 220e), and with an approximate position of GPS antenna 220f on the body top near the front-the positions 220d-220f are further illustrated in information 290e of FIG. 2E, in which the example earth-moving vehicle is shown using an upper-side-back view, with GPS antenna 220f shown on the body top near the front on the same side as GPS antenna 220e. While not illustrated in FIGS. 2D-2E, some or all of the GPS antennas may be enabled to receive and use RTK data to further improve the accuracy of the GPS signals that are produced, such as by each being part of or otherwise associated with a GPS receiver including an RTK radio that receives and uses RTK-based GPS correction data transmitted from a base station (e.g., at a location remote from the site at which the vehicle is located) to improve accuracy of the GPS signals from the GPS antennas, so as to be part of one or more RTK-enabled GPS positioning units. The vehicle may further have one or more INS-DU or other IMU units, which are not shown in this example. It will be appreciated that other quantities, positionings and types of GPS antennas (and/or antennas for other types of satellite-based navigation systems) and/or inclinometers and/or other sensors/components may be used in other embodiments.

FIGS. 2F and 2G continue the examples of FIGS. 2D-2E, and illustrate information 290f and 290g respectively to show an example of an alternative configuration of a bulldozer vehicle 170c/175c in which the vehicle is equipped with both a front tool attachment and a rear tool attachment. In the example embodiment of FIG. 2F, the front tool attachment is a blade 211f, and the rear tool attachment is a ripper 224f with one or more teeth. In the example embodiment of FIG. 2G, the front tool attachment is similarly a blade 211g, and the rear tool attachment is similarly a ripper 224g with a single tooth. Various sensors and components may be positioned on the vehicle in a manner similar to that of FIGS. 2D-2E, including illustrated elements 140, 210e-210i, 215, 220d-220f, 250 and 260.

FIGS. 2H and 2I illustrate respective information 290h and 290i about a variety of non-exclusive example types of powered earth-moving construction vehicles 170 and powered earth-moving mining vehicles 175 that may be controlled by embodiments of the EMVAOC system. FIG. 2H includes two example earth-moving tracked construction excavator vehicles 170a shown with different attachments (excavator vehicle 170a1 with a bucket attachment, and excavator vehicle 170a2 with a grapple attachment) that may be controlled by the EMVAOC system. Other example types of earth-moving construction vehicles 170 that are illustrated in FIG. 2H include a bulldozer 170c; a backhoe loader 170d; a wheel loader 170e; a skid steer loader 170f; a dump truck 170j; a forklift 170g; a trencher 170h; a mixer truck 170i; a flatbed truck 170k; a motorized grader 170l; a wrecking ball crane 170m; a truck crane 170n; a cherry picker 170p; a heavy hauler 170q; a scraper 170r; a pile driver 170o; a road roller 170b; etc. It will be appreciated that other types of earth-moving construction vehicles may similarly be controlled by the EMVAOC system in other embodiments. In a similar manner, FIG. 2I illustrates several example earth-moving tracked mining excavator vehicles 175a shown with different attachments (excavator vehicle 175a1 with a bucket attachment, excavator vehicle 175a3 with a dragline attachment, excavator vehicle 175a4 with a clamshell extractor attachment, excavator vehicle 175a5 with a front shovel attachment, excavator vehicle 175a6 with a bucket wheel extractor attachment, excavator vehicle 175a7 with a power shovel attachment, etc.) that may be controlled by the EMVAOC system. Other example types of earth-moving mining vehicles 175 that are illustrated in FIG. 2I include a dump truck 175m; an articulated dump truck 175n; a mining dump truck 175b; a bulldozer 175c; a scraper 175d; a tractor scraper 175g; a wheel loader 175e; a wheeled skid steer loader 175f; a tracked skid steer loader 175i; a wheeled excavator 175h; a backhoe loader 175k; a motor grader 175j; a trencher 175l; etc. It will be appreciated that other types of earth-moving mining vehicles may similarly be controlled by the EMVAOC system in other embodiments. In addition, while various types of sensors are not illustrated in FIGS. 2H-2I, it will be appreciated that such sensors (e.g., LiDAR sensors, image sensors of cameras, infrared sensors, material type sensors, etc.) may be mounted on the respective powered earth moving vehicles 170 and/or 175 at various positions, such as at the same or analogous positions as the sensors discussed with respect to FIGS. 2A-2G, or instead in other positions.

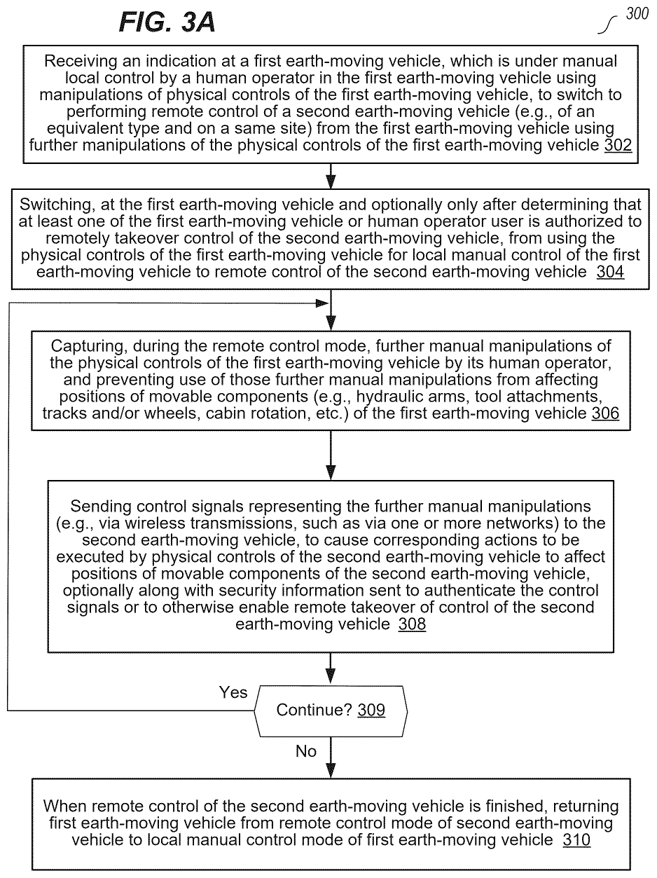

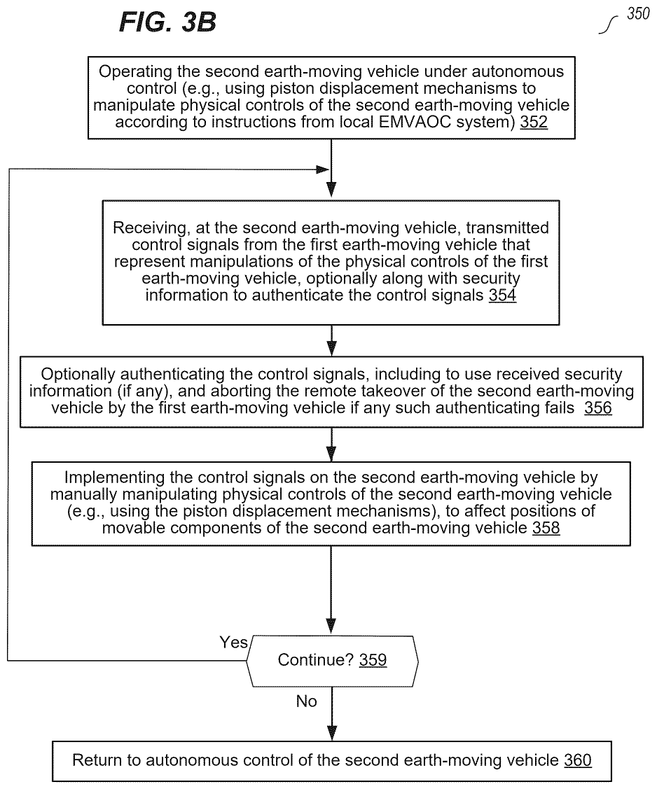

FIGS. 3A-3B are example flow diagrams 300 and 350 of illustrated embodiments of performing remote control of a second earth-moving vehicle using physical controls of a separate first earth-moving vehicle, such as by performing computer-implemented methods for switching from local manual control of the first earth-moving vehicle using local manual manipulations of physical controls of the first earth-moving vehicle to remote control of the second earth-moving vehicle from the first earth-moving vehicle using further manual manipulations of the physical controls of the first earth-moving vehicle. Thus, the flow diagrams 300 and 350 illustrate examples of remote control switching from manual control of a first earth-moving mining and/or construction vehicle to remote control of a second earth-moving vehicle, such as to be implemented by execution of a local/remote switching control module 148 or otherwise by an embodiment of an EMVAOC system.

As shown at 302, a first earth-moving vehicle 199a may receive a request or other indication to perform remote takeover and remote control of a second earth-moving vehicle 199b. In some implementations, the first earth-moving vehicle and the second earth-moving vehicle may be equivalent or substantially equivalent, such that physical controls 176 (e.g., the joysticks, pedals, buttons, etc.) are the same or otherwise similar enough that commands from one vehicle 199a can be passed to the equivalent vehicle 199b. In some implementations, a request to switch from the first earth-moving vehicle 199a to the second earth-moving vehicle 199b may be provided by the EMVAOC system 140 on the second vehicle, such as in response to autonomous control of the second earth-moving vehicle 199b encountering a problem, etc. Alternatively, the human operator 154 of the first vehicle may initiate the remote takeover, such as by interacting with a display screen on the first earth-moving vehicle 199a that signals to switch from a local control mode to a remote control mode that includes a remote takeover by the human operator 154 of the second earth-moving vehicle 199b. At 304, the first earth-moving vehicle 199a optionally determines that the remote takeover of the second earth-moving vehicle 199b is authorized, such as based on information specific to the first vehicle and/or to the second vehicle and/or to the human operator (e.g., based on a control code or password or other security information supplied by the human operator, based on predefined configuration on whether and when remote takeover is permitted between all and/or specific vehicles, etc.), and if so or instead if such authorization determination is not performed, switches from a manual local control mode, where control signals at the physical controls 162 of the first vehicle are passed to the movable components 174a of the first vehicle, to a remote control mode where at 306, the control signals from further manipulations of the physical controls 162 of the first vehicle are captured by the remote control switching component 176a of the first vehicle 199a.

At 308, the remote control switching component 176a on the first vehicle then sends the captured manual control signals to the second earth-moving vehicle 199b (e.g., via an intervening transmission network, optionally including direct vehicle-to-vehicle communication), optionally along with security information to authenticate the control signals and/or the remote takeover (e.g., using information received or determined in block 304), with the captured manual control signals provided to the components 174b of the second earth-moving vehicle 199b by the remote control switching component 176b of the second earth-moving vehicle 199b if the remote takeover and/or remote control is determined to be authorized (e.g., based in part or in whole on the sent security information) or if such authorization determination is not performed. In this manner, the human operator 154 (when authorized) remotely controls the second earth-moving vehicle 199b while positioned within the cabin/housing of the first earth-moving vehicle 199b and based on manipulations of the physical controls of the first earth-moving vehicle 199a, to thereby cause the movable components of the second earth-moving vehicle 199b to move in response to the physical control manipulations that occur on the first vehicle. In some implementations, the indication at block 302 may include information transmitted from the second vehicle, such as current positions of the physical controls 162b of the second earth-moving vehicle 199b and/or data from one or more sensors of the second vehicle, and may be displayed to the human operator on the first vehicle in blocks 302 and/or 304 and/or 306, or such data and other information may instead be requested by the first vehicle in one or more of blocks 302-306 and used in that same manner. In some embodiments, this causes the physical controls 162a of the first earth-moving vehicle 199a to be reset during remote control to the same positions of the physical controls 162b of the second earth-moving vehicle 199b, such as before the remote control manipulations by the human operator, to further mimic the experience for the human operator 154 of being inside of the remote controlled vehicle 199b. For example, if the joystick of the second vehicle is pushed forward to fully extend the boom arm of the second earth-moving vehicle 199b at a time when the remote control mode is initiated at the first earth-moving vehicle 199a, the joystick component of the first earth-moving vehicle 199a may be repositioned to match a position of the joystick in the second earth-moving vehicle 199b. In further implementations, during such remote control, the physical controls 162 of the first vehicle may be set in a default position on which a human operator 154 may begin providing inputs. At 309, a determination is made of whether to continue the remote control of the second vehicle, such as until an indication to stop is received or determined, or instead only if an indication to continue is received or determined, and if so returns to 306, and otherwise continues to 310. At 310, the first earth-moving vehicle 199a may then switch from the remote control mode involving control of the second earth-moving vehicle 199b back to the local control mode involving manual control of the first earth-moving vehicle 199a, in order to continue manual operations of the first earth-moving vehicle 199a by the human operator of the first vehicle. In some embodiments, the EMVAOC system 140 may provide instructions for the second earth-moving vehicle 199b to resume autonomous operations on the worksite.

As shown at 352 from the perspective of the second powered earth-moving vehicle, the second vehicle may initially be operating in a local control mode under autonomous control (e.g., using piston displacement mechanisms of the second vehicle to manipulate physical controls of the second vehicle according to instructions from a local EMVAOC system executing on the second vehicle). At 354, the second vehicle receives transmitted control signals from the first vehicle (e.g., as transmitted in block 308) that represent manipulations of the physical controls of the first earth-moving vehicle, optionally along with instructions to initiate the remote takeover, and/or optionally along with security information (e.g., about the first vehicle and/or its human operator user) to enable a determination of whether the remote takeover activity and/or the received control signals are authenticated. At 356, the second vehicle optionally authenticates the remote takeover activity and/or the received control signals, such as based in part or in whole on the received security information and/or based on configuration information stored at or available to the second vehicle (e.g., to specify whether and when another vehicle may remotely takeover the second vehicle, such as for any other vehicle or for particular other vehicles)—if the authentication determination is initiated but is not successful, the second vehicle may abort the remote takeover, and continue with its prior autonomous control activities. At 358, if the authentication determination of block 356 succeeds or is not performed, the received control signals are implemented on the second vehicle by manually manipulating physical controls of the second vehicle (e.g., using piston displacement mechanisms of the second vehicle), to affect positions of movable components of the second earth-moving vehicle in accordance with the physical manipulations of the first physical controls of the first vehicle that the received control signals represent. At 359, a determination is made of whether to continue the remote control of the second vehicle, such as until an indication to stop is received or determined, or instead only if an indication to continue is received or determined, and if so returns to 354, and otherwise continues to 360. At 360, the second vehicle then ends the remote control mode, and returns to local control mode and corresponding autonomous control of the second vehicle.

Aspects of the present disclosure are described herein with reference to flowchart illustrations and/or block diagrams of methods, apparatus (systems), and computer program products according to embodiments of the present disclosure. It will be appreciated that each block of the flowchart illustrations and/or block diagrams, and combinations of blocks in the flowchart illustrations and/or block diagrams, can be implemented by computer readable program instructions. It will be further appreciated that in some implementations the functionality provided by the routines discussed above may be provided in alternative ways, such as being split among more routines or consolidated into fewer routines. Similarly, in some implementations illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel, or synchronous or asynchronous) and/or in a particular order, in other implementations the operations may be performed in other orders and in other manners. Any data structures discussed above may also be structured in different manners, such as by having a single data structure split into multiple data structures and/or by having multiple data structures consolidated into a single data structure. Similarly, in some implementations illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited except as by corresponding claims and the elements recited therein. In addition, while certain aspects of the invention may be presented in certain claim forms at certain times, the inventors contemplate the various aspects of the invention in any available claim form. For example, while only some aspects of the invention may be recited as being embodied in a computer-readable medium at particular times, other aspects may likewise be so embodied.

What is claimed is:

1. A remote control vehicle switching system, comprising:
a first powered earth-moving vehicle with a body, first movable components that include one or more hydraulic arms and one or more tool attachments and at least one of wheels or tracks, and first physical controls for use in initiating changes to positions of the first movable components in response to manipulations of the first physical controls by a human operator user located on the first powered earth-moving vehicle;
a remote control switching component on the first powered earth-moving vehicle that has a local control mode and a remote control mode and is configured to direct control signals from the manipulations of the first physical controls to the first movable components on the first powered earth-moving vehicle if in the local control mode, and to one or more other powered earth-moving vehicles via wireless transmissions if in the remote control mode; and
a control system on the first powered earth-moving vehicle that is configured to communicate with the remote control switching component and to perform automated operations including:
switching, in response to received instructions that indicate a second powered earth-moving vehicle having second physical controls of a same type as the first physical controls on the first earth-moving vehicle, the remote control switching component on the first powered earth-moving vehicle from the local control mode to the remote control mode, the remote control mode being configured to send the wireless transmissions to the indicated second powered earth-moving vehicle;
capturing, after the switching, further manipulations of the first physical controls on the first powered earth-moving vehicle by the human operator user;
sending one or more control signals representing the further manipulations via one or more wireless transmissions to the second powered earth-moving vehicle, to cause respective changes to positions of second movable components of the second powered earth-moving vehicle in response to the sent one or more control signals representing the further manipulations; and
further switching, after the sending of the one or more control signals, the remote control switching component on the first powered earth-moving vehicle from the remote control mode to the local control mode, to enable additional respective changes to the positions of the first movable components of the first powered earth-moving vehicle in response to additional manipulations of the first physical controls on the first powered earth-moving vehicle by the human operator user.

2. The remote control vehicle switching system of claim 1 wherein the first and second powered earth-moving vehicles are a same type of vehicle.

3. The remote control vehicle switching system of claim 1 wherein the first and second powered earth-moving vehicles have a same type of one or more tool attachments, and wherein at least some of the respective changes to the positions of the second movable components include changes to a position of at least one of the one or more tool attachments on the second powered earth-moving vehicle.

4. The remote control vehicle switching system of claim 1 wherein the first and second powered earth-moving vehicles have a same type of one or more hydraulic arms, and wherein at least some of the respective changes to the positions of the second movable components include changes to a position of at least one of the one or more hydraulic arms on the second powered earth-moving vehicle.

5. The remote control vehicle switching system of claim 1 wherein the first and second powered earth-moving vehicles have a same type of physical controls that include at least one of one or more pedals, or one or more joysticks, or one or more buttons.

6. The remote control vehicle switching system of claim 5 further comprising the second powered earth-moving vehicle, the second movable components of the second powered earth-moving vehicle including one or more second hydraulic arms and one or more second tool attachments and at least one of second wheels or tracks, and the second physical controls including at least one of one or more second pedals, or one or more second joysticks, or one or more second buttons, and wherein the automated operations further include:
receiving, at the second powered earth-moving vehicle, the sent one or more control signals representing the further manipulations via the one or more wireless transmissions; and
initiating, at the second powered earth-moving vehicle, the respective changes to the second movable components of the second powered earth-moving vehicle in response to the received one or more control signals representing the further manipulations.

7. The remote control vehicle switching system of claim 6 wherein the second powered earth-moving vehicle further has a second remote control switching component, and wherein the initiating of the respective changes to the second movable components of the second powered earth-moving vehicle is performed by the second remote control switching component after determining that at least one of the first powered earth-moving vehicle or the human operator user are authorized to remotely takeover control of the second powered earth-moving vehicle based at least in part on security information included with the sent one or more control signals, and includes using one or more piston displacement mechanisms on the second powered earth-moving vehicle to manipulate at least one of the second physical controls.

8. The remote control vehicle switching system of claim 1 wherein the switching is performed in response to instructions received from a source external to the first powered earth-moving vehicle, and wherein the automated operations further include:
receiving, before the switching, initial manipulations of the first physical controls on the first powered earth-moving vehicle by the human operator user, and initiating initial respective changes to the positions the first movable components in response to the initial manipulations; and
receiving, after the further switching, the additional manipulations of the first physical controls on the first powered earth-moving vehicle by the human operator user, and initiating the additional respective changes to the positions of the first movable components in response to the additional manipulations.

9. The remote control vehicle switching system of claim 1 wherein the first and second powered earth-moving vehicles are both on a work site and in respective locations in which the second powered earth-moving vehicle is visible from a cabin of the first powered earth-moving vehicle in which the first human operator user is located, wherein the switching and the further switching is performed in response to instructions received from the human operator user, and wherein the automated operations further include:
receiving, after the further switching, additional instructions from the human operator user to switch the remote control switching component on the first powered earth-moving vehicle from the local control mode to the remote control mode for use in controlling an indicated third powered earth-moving vehicle separate from the first and second powered earth-moving vehicles;
additionally switching, in response to the received additional instructions, the remote control switching component on the first powered earth-moving vehicle from the local control mode to the remote control mode for use in controlling the third powered earth-moving vehicle;
additionally capturing, after the additional switching, further additional manipulations of the first physical controls on the first powered earth-moving vehicle by the human operator user; and
additionally sending one or more additional control signals representing the further additional manipulations via one or more additional wireless transmissions to the third powered earth-moving vehicle, to cause further respective changes to positions of third movable components of the third powered earth-moving vehicle in response to the sent one or more additional control signals representing the further additional manipulations.

10. The remote control vehicle switching system of claim 1 wherein the one or more wireless transmissions are sent between the first and second powered earth-moving vehicles using at least one of direct vehicle-to-vehicle transmission or a communication network having one or more intermediate devices through which the wireless transmissions pass, wherein the switching further includes requesting, via additional wireless transmissions, sensor data from sensors on the second powered earth-moving vehicle that include at least one of a camera providing visual data or a LiDAR component providing LiDAR data, and wherein the capturing of the further manipulations occurs concurrently with presenting, to the human operator user on a display in a cabin of the first powered earth-moving vehicle, the sensor data from the sensors on the second powered earth-moving vehicle.

11. The remote control vehicle switching system of claim 1 wherein the automated operations further include, at a time when the first powered earth-moving vehicle is operating autonomously without any human operator user:
receiving additional instructions at the first powered earth-moving vehicle via one or more received further wireless transmissions to switch the remote control switching component on the first powered earth-moving vehicle from the local control mode to the remote control mode for use in receiving control signals from a third powered earth-moving vehicle separate from the first and second powered earth-moving vehicles;
additionally switching, in response to the received additional instructions, the remote control switching component on the first powered earth-moving vehicle from the local control mode to the remote control mode;
receiving one or more additional control signals at the first powered earth-moving vehicle that are transmitted via one or more additional wireless transmissions from the third powered earth-moving vehicle and that represent further manipulations of third physical controls on the third powered earth-moving vehicle by an additional human operator user on the third powered earth-moving vehicle; and
initiating further respective changes to the positions of the first movable components of the first powered earth-moving vehicle in response to the received one or more additional control signals representing the further manipulations.

12. The remote control vehicle switching system of claim 1 wherein the first and second powered earth-moving vehicles are each one of a bulldozer vehicle or a track loader vehicle or a skid steer loader vehicle or an excavator vehicle, and wherein the switching of the remote control switching component on the first powered earth-moving vehicle includes determining that at least one of the first powered earth-moving vehicle or the human operator user are authorized to remotely takeover control of the second powered earth-moving vehicle.

13. The remote control vehicle switching system of claim 1 wherein the first powered earth-moving vehicle further includes:
a microcontroller unit configured to effect movement of the one or more first physical controls via one or more piston displacement mechanisms as part of autonomous operations of the first powered earth-moving vehicle without the human operator user;
one or more sensors configured to provide data readings about a location and orientation of the body, including one or more GPS antennas mounted at one or more positions on the body and capable of receiving GPS signals for use in determining GPS coordinates of at least the one or more positions; and
at least one of a LiDAR component that is mounted on the first powered earth-moving vehicle and configured to capture LiDAR data indicating a plurality of three-dimensional (“3D”) points on surfaces of at least some of an environment of the first powered earth-moving vehicle, or an image sensor of a camera component that is mounted on the first powered earth-moving vehicle and configured to obtain images of at least some of the environment of the first powered earth-moving vehicle,
and wherein the control system is configured to implement at least some automated operations of an earth-moving vehicle autonomous operations control system by executing software instructions of the earth-moving vehicle autonomous operations control system without receiving external signals other than GPS signals and real-time kinematic (RTK) correction signals.

14. The remote control vehicle switching system of claim 1 wherein the sending of the one or more control signals representing the further manipulations via the one or more wireless transmissions to the second powered earth-moving vehicle includes using at least one of a centralized star network including at least the first and second powered earth-moving vehicles and at least one additional device through which the one or more wireless transmissions pass, or a mesh network having a plurality of powered earth-moving vehicles that include the first and second powered earth-moving vehicles and one or more additional powered earth-moving vehicles and with wireless transmissions passing between at least some pairs of the plurality of powered earth-moving vehicles, or direct communications between the first and second powered earth-moving vehicles in a peer-to-peer manner.

15. A computer-implemented method, comprising:
switching, at a first powered earth-moving vehicle being operated by a human operator user located on the first powered earth-moving vehicle, and by one or more hardware processors on the first powered earth-moving vehicle, from a local control mode in which manipulations of first physical controls on the first powered earth-moving vehicle by the human operator user cause respective changes to first movable components of the first powered earth-moving vehicle, to a remote control mode in which further manipulations of the first physical controls on the first powered earth-moving vehicle by the human operator user cause further respective changes to second movable components of a remote second powered earth-moving vehicle;
capturing, after the switching and by the one or more hardware processors, at least some of the further manipulations of the first physical controls on the first powered earth-moving vehicle by the human operator user;
sending, by the one or more hardware processors, one or more control signals representing the at least some further manipulations via one or more wireless transmissions from the first powered earth-moving vehicle to the second powered earth-moving vehicle, to cause at least some of the further respective changes to the second movable components of the second powered earth-moving vehicle in response to the sent one or more control signals representing the at least some further manipulations; and
switching, by the one or more hardware processors and after the sending of the one or more control signals, the first powered earth-moving vehicle from the remote control mode to the local control mode, to enable additional respective changes to the first movable components of the first powered earth-moving vehicle in response to additional manipulations of the first physical controls on the first powered earth-moving vehicle by the human operator user.

16. The computer-implemented method of claim 15 wherein the first and second powered earth-moving vehicles have at least one of a same type of vehicle, or a same type of one or more tool attachments, or a same type of one or more hydraulic arms, or a same type of physical controls that include at least one of one or more pedals, or one or more joysticks, or one or more buttons.

17. The computer-implemented method of claim 15 further comprising:
receiving, at the second powered earth-moving vehicle, the sent one or more control signals representing the further manipulations via the one or more wireless transmissions, wherein the second movable components of the second powered earth-moving vehicle include one or more second hydraulic arms and one or more second tool attachments and at least one of second wheels or tracks, and wherein the second physical controls include at least one of one or more second pedals, or one or more second joysticks, or one or more second buttons; and
initiating, at the second powered earth-moving vehicle, the respective changes to the second movable components of the second powered earth-moving vehicle in response to the received one or more control signals representing the further manipulations.

18. The computer-implemented method of claim 17 wherein the second powered earth-moving vehicle further has a second remote control switching component, and wherein the initiating of the respective changes to the second movable components of the second powered earth-moving vehicle is performed by the second remote control switching component after determining that at least one of the first powered earth-moving vehicle or the human operator user are authorized to remotely takeover control of the second powered earth-moving vehicle, and includes using one or more piston displacement mechanisms on the second powered earth-moving vehicle to manipulate at least one of the second physical controls.

19. A non-transitory computer-readable medium having stored contents that cause one or more one or more hardware processors to perform automated operations including at least:
receiving, at a second powered earth-moving vehicle on which the one or more hardware processors are located and that is operating in a local control mode in which manipulations of second physical controls on the second powered earth-moving vehicle are autonomously controlled by an autonomous control system on the second powered earth-moving vehicle and cause respective changes to second movable components of the second powered earth-moving vehicle, instructions to switch from the local control mode to a remote control mode in which additional manipulations of the second physical controls on the second powered earth-moving vehicle are controlled by a remote first powered earth-moving vehicle under control of a human operator user on the first powered earth-moving vehicle, the received instructions including one or more control signals representing additional manipulations performed by the human operator user of one or more first physical controls on the first powered earth-moving vehicle;
switching, at the second powered earth-moving vehicle and in response to the received instructions, from the local control mode to the remote control mode;
manipulating, at the second powered earth-moving vehicle, at least one of the second physical controls to cause further respective changes to the second movable components of the second powered earth-moving vehicle, wherein the manipulating is performed based on the one or more control signals to correspond to the additional manipulations performed by the human operator user of one or more first physical controls on the first powered earth-moving vehicle; and
further switching, at the second powered earth-moving vehicle and in response to additional received instructions, the second powered earth-moving vehicle from the remote control mode to the local control mode, to enable additional respective changes to the second movable components of the second powered earth-moving vehicle to be performed in response to additional manipulations of the second physical controls on the second powered earth-moving vehicle under autonomous control of the autonomous control system on the second powered earth-moving vehicle.

20. The non-transitory computer-readable medium of claim 19 wherein the first and second powered earth-moving vehicles have at least one of a same type of vehicle, or a same type of one or more tool attachments, or a same type of one or more hydraulic arms, or a same type of physical controls that include at least one of one or more pedals, or one or more joysticks, or one or more buttons, wherein at least one of the manipulating or the switching from the local control mode to the remote control mode is performed by a remote control switching component on the second powered earth-moving vehicle after determining that at least one of the first powered earth-moving vehicle or the human operator user are authorized to remotely takeover control of the second powered earth-moving vehicle, and wherein the manipulating uses one or more piston displacement mechanisms on the second powered earth-moving vehicle to manipulate the at least one of the second physical controls.
